(19) United States
(12) Patent Application Publication
(10) Pub. No.: US 2013/0010728 A1
(43) Pub. Date: Jan. 10, 2013

(54) WIRELESS TERMINAL APPARATUS, COMMUNICATION APPARATUS, AND WIRELESS COMMUNICATION SYSTEM

(75) Inventor: Naoki OGUCHI, Kawasaki (JP)

(73) Assignee: FUJITSU LIMITED, Kawasaki-shi (JP)

(21) Appl. No.: 13/616,422

(22) Filed: Sep. 14, 2012

Related U.S. Application Data
(63) Continuation of application No. PCT/JP2010/054629, filed on Mar. 18, 2010.

(51) Int. Cl. H04W 76/02

(52) U.S. Cl. 370/329

(57) ABSTRACT

A wireless terminal apparatus is capable of switching between a first mode in which connection to a wireless access network is established and a second mode in which the connection to the wireless access network is temporarily released. The wireless terminal apparatus has a data processing unit and a transmitting unit. The data processing unit generates data to be transmitted to the wireless access network. The transmitting unit includes at least a part of the data generated by the data processing unit during the second mode in a control message to be transmitted to the wireless access network in the second mode, and transmits the data.

### CROSS-REFERENCE TO RELATED APPLICATION

This application is a continuation application of International Application PCT/JP2010/054629 filed on Mar. 18, 2010 and designated the U.S., the entire contents of which are incorporated herein by reference.

### FIELD

The embodiments discussed herein are related to a wireless terminal apparatus, a communication apparatus, and a wireless communication system.

### BACKGROUND

Wireless communication systems have been widely used today, including cellular phone systems, wireless MANs (Metropolitan Area Networks), and wireless LANs (Local Area Networks). For example, communication specifications referred to as Wi-Fi (IEEE 802.11), ZigBee (IEEE 802.15.4), and WiMAX (IEEE 802.16) are used. The above-described wireless communication systems may be used for various usages. For example, think that measurement devices report measurement values through a wireless access network (telemetering). Examples of the telemetering include sale management for automatic vending machine, meter reading of electricity, gas, and water, and charging management of unmanned parking lot.

Incidentally, to some wireless terminal devices connected to a wireless access network, suppression of power consumption is requested. To solve the problem, after a wireless terminal device is connected to a wireless access network, some wireless communication systems temporarily release the connection and realize electric power saving during the period at which traffic is not generated. In WiMAX, for example, an idle mode is specified as an operation mode of the wireless terminal device.

In the idle mode, the wireless access network keeps a parameter (context) used for connection to the wireless terminal device, and then releases resources allocated to the wireless terminal device. During the idle mode, the wireless access network regularly broadcasts a message (paging message) representing the presence or absence of downlink traffic. The wireless terminal device repeats an Unavailable section in which a receiving process is not performed and an Available section in which a paging massage is received until generation of the traffic is detected. When the traffic is generated, a procedure of reconnection between the wireless access network and the wireless terminal device is performed by using the kept context.

With regard to a technology of performing data communication by using a line of a cellular phone, there is proposed a method in which a data transmission terminal device transmits data to a speech line as a dial signal in the case where the speech line of a wireless phone is formed between a data transmission terminal device and a data collection device (see, for example, Japanese Laid-open Patent Publication No. 2000-152340).

However, in a conventional technology in which connection between a wireless access network and a wireless terminal device is temporarily released, data communication may become inefficient in the case where traffic is generated between the wireless access network and the wireless terminal device.

Specifically, the wireless terminal device may repeat a process in which when traffic is generated in a state where connection to a wireless access network is temporarily released, reconnection to a wireless access network is performed, and further when data transmission is finished, the reconnection to the wireless access network is released again. At this time, there arises a problem in an overhead of repeating reconnection and release when a size of data to be transmitted once is relatively small. For example, this overhead is disadvantageous in terms of increasing the quantity of radio resources used or power consumption of the wireless terminal device.

### SUMMARY

In one aspect of the embodiments, there is provided a wireless terminal apparatus capable of switching between a first mode in which connection to a wireless access network is established and a second mode in which the connection to the wireless access network is temporarily released. The wireless terminal apparatus includes: a data processing unit configured to generate data to be transmitted to the wireless access network; and a transmitting unit configured to include at least a part of data generated by the data processing unit during the second mode in a control message to be transmitted to the wireless access network in the second mode, and transmit the data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a wireless communication system according to a first embodiment;

FIG. 2 illustrates a wireless communication system according to a second embodiment;

FIG. 3 is a block diagram illustrating a base station control device;

FIG. 4 is a block diagram illustrating a wireless base station;

FIG. 5 is a block diagram illustrating a wireless terminal apparatus;

FIG. 6 illustrates a data type of data to be collected;

FIG. 7 illustrates an example of a transfer table (base station control device);

FIG. 8 illustrates an example of a transfer table (wireless terminal apparatus);

FIG. 9 is a sequence diagram illustrating a flow of data transfer setting;

FIG. 10 illustrates an example of a signaling request message;

FIG. 11 is a first diagram illustrating an example of a Path_Dereg_Req message;

FIG. 12 is a second diagram illustrating an example of a Path_Dereg_Req message;

FIG. 13 illustrates an example of a DREG-CMD message;

FIG. 14 illustrates an example of a DREG-REQ message;

FIG. 15 illustrates an example of a Path_Dereg_Rsp message;

FIG. 16 illustrates an example of a signaling response message;

FIG. 17 is a flowchart illustrating terminal processing according to a second embodiment;

FIG. 18 is a flowchart illustrating base station control processing according to a second embodiment;

FIG. 19 is a sequence diagram illustrating a flow of a first data transfer according to a second embodiment;

FIG. 20 is a sequence diagram illustrating a flow of a second data transfer according to a second embodiment;

FIG. 21 illustrates an example of an RNG-REQ message;

FIG. 22 illustrates an example of an LU-Req message;

FIG. 23 illustrates an example of a report message;

FIG. 24 illustrates an operation instruction to a wireless terminal apparatus;

FIG. 25 is a flowchart illustrating terminal processing according to a third embodiment;

FIG. 26 is a sequence diagram illustrating a flow of a first data transfer according to a third embodiment;

FIG. 27 is a sequence diagram illustrating a flow of a second data transfer according to a third embodiment;

FIG. 28 illustrates an example of a MOB_PAG-ADV message;

FIG. 29 illustrates another example of a signaling request message; and

FIG. 30 is a sequence diagram illustrating a flow of a data transfer according to a fourth embodiment.

### DESCRIPTION OF EMBODIMENTS

Preferred embodiments of the present invention will now be described in detail below with reference to the accompanying drawings, wherein like reference numerals refer to like elements throughout.

### First Embodiment

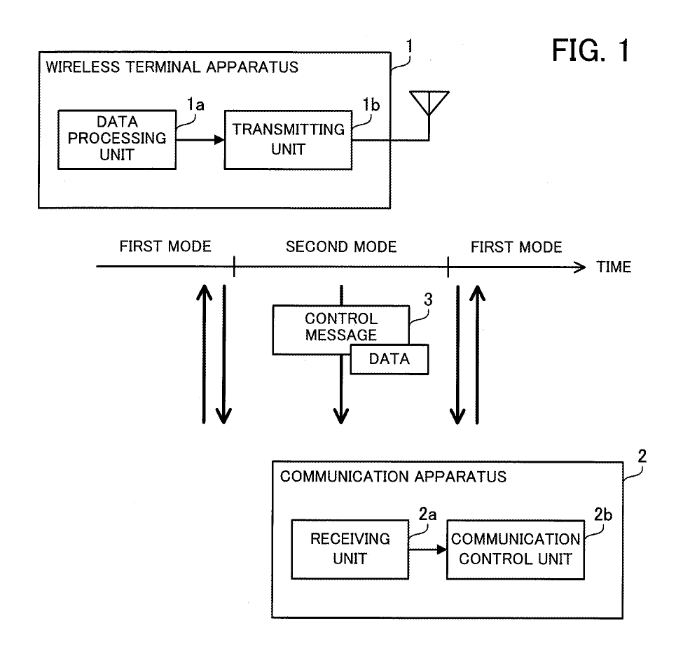

FIG. 1 illustrates a wireless communication system according to a first embodiment. The wireless communication system according to the first embodiment includes a wireless terminal apparatus 1 and a communication apparatus 2. The wireless terminal apparatus 1 is a terminal apparatus which is connected to a wireless access network and transmits data, and may be a fixed terminal apparatus or a mobile terminal apparatus. The communication apparatus 2 is an apparatus provided on a wireless access network and, for example, a wireless base station or a base station control device which controls a wireless base station.

The wireless terminal apparatus 1 switches between a first mode in which connection to the wireless access network is established and a second mode in which the connection to the wireless access network is temporarily released after establishing the connection for operation. In the case where this wireless communication system is implemented as a WiMAX, the first mode is considered as a normal mode, and the second mode is considered as an idle mode. In the wireless terminal apparatus 1, a receiving process may be intermittently stopped during the second mode. For example, the stoppage of the receiving process is performed through stoppage of a power supply to the receiving circuit or reduction in a clock of the receiving circuit.

The wireless terminal apparatus 1 has a data processing unit 1a and a transmitting unit 1b. The data processing unit 1a generates data to be transmitted to the wireless access network. Examples of the generated data include measured data in telemetering. The transmitting unit 1b includes at least a part of data generated by the data processing unit 1a during the second mode in a control message 3 to be transmitted to the wireless access network in a state where connection to the wireless access network is released, and transmits the data. As the control message 3, for example, a ranging request message is used.

Here, according to a type of the data generated by the data processing unit 1a, the transmitting unit 1b may select whether data is included in the control message and transmitted, or the reconnection to the wireless access network is performed (namely, the transmitting unit 1b switches from the second mode to the first mode) and data is transmitted as a data message. For example, think that a type of data having a relatively small size is included in the control message 3 and transmitted. A relationship between a type and transmission method of data may be set at the time when the wireless terminal apparatus 1 switches from the first mode to the second mode. This relationship may be specified from the wireless access network.

In the case where a plurality of types of data are transmitted, when a type of data failing to be included in the control message 3 and transmitted is partially included, the transmitting unit 1b may switch from the second mode to the first mode and transmit all the plurality of types of data. Even if only a part of data is included in the control message 3 and transmitted, this is effective in the case of failing to make a contribution to improvement in the communication efficiency. When the control message is received as an opportunity from the wireless access network during the second mode, the transmitting unit 1b may further transmit the data generated by the data processing unit 1a. Examples of the control message include a paging message.

The communication apparatus 2 has a receiving unit 2a and a communication control unit 2b. The receiving unit 2a receives the control message 3 transmitted by the wireless terminal apparatus 1. In the case where the communication apparatus 2 is a wireless base station, the receiving unit 2a receives the control message 3 transmitted through a wireless section. In the case where the communication apparatus 2 is a base station control device, the receiving unit 2a receives the control message 3 transferred by the wireless base station. The receiving unit 2a may further receive the data message transmitted in the first mode by the wireless terminal apparatus 1.

The communication control unit 2b extracts data included in the control message 3 received by the receiving unit 2a and transfers it to a predetermined communication apparatus. In the case of receiving the data message, the receiving unit 2a transfers it to the predetermined communication apparatus.

Here, according to a type of data included in the control message 3 received by the receiving unit 2a, the communication control unit 2b may determine whether to transfer the data to the predetermined communication apparatus. A relationship between a type of the data and the transfer may be set at the time when the wireless terminal apparatus 1 switches from the first mode to the second mode. The above relationship is considered to be the same as that set in the wireless terminal apparatus 1. Through signaling, the communication control unit 2b may instruct the wireless terminal apparatus 1 to set the above relationship. When the switching between the first mode and the second mode is repeated, when the above-described relationship is already set, the communication control unit 2b eliminates the need for resetting.

In the above-described wireless communication system according to the first embodiment, data to be transmitted to the wireless access network is generated through the data processing unit 1a of the wireless terminal apparatus 1. Through the transmitting unit 1b of the wireless terminal apparatus 1, at least a part of the data generated during the second mode is included in the control message 3 to be transmitted to the wireless access network and transmitted in the state where the connection to the wireless access network is released. Through the receiving unit 2a of the communication apparatus 2, the control message 3 transmitted by the wireless terminal apparatus 1 is received. Through the communication control unit 2b of the communication apparatus 2, the data included in the control message 3 is extracted.

This feature makes it possible to transmit data more efficiently from the wireless terminal apparatus 1 to the wireless access network. That is, the wireless terminal apparatus 1 transmits data as it is in the second mode in which the connection to the wireless access network is temporarily released, and eliminates the need to be reconnected to the wireless access network. Accordingly, consumption of radio resources along with reconnection is suppressed and power consumption of the wireless terminal apparatus 1 is suppressed. When the connection between the wireless terminal apparatus 1 and the wireless access network is suppressed, the number of wireless terminal apparatus capable of being accommodated in the wireless base station is capable of being increased.

Second to fourth embodiments to be described below assume that the communication method described in the first embodiment is applied to the wireless communication system compliant with specifications of WiMAX of IEEE 802.16e-2005 or later. Note that the communication method described in the first embodiment may be applied to other types of wireless communication systems.

### Second Embodiment

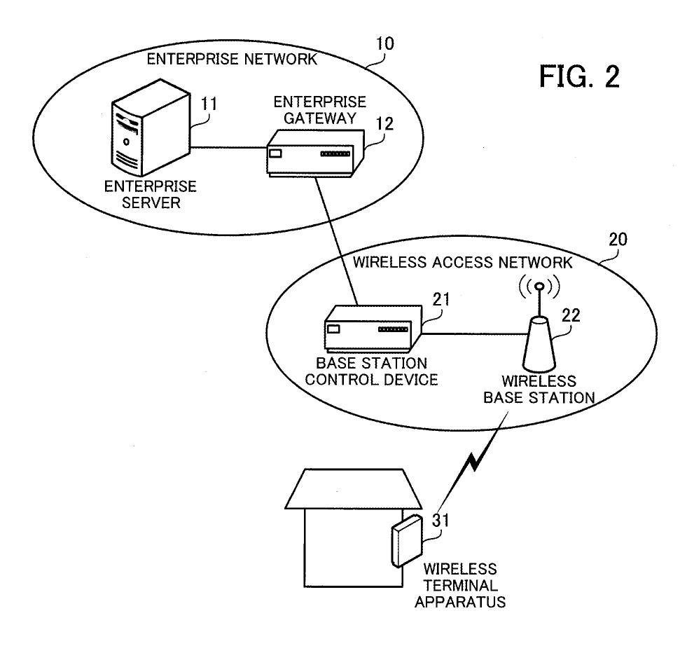

FIG. 2 illustrates a wireless communication system according to a second embodiment. The wireless communication system according to the second embodiment includes an enterprise server 11, an enterprise gateway 12, a base station control device 21, a wireless base station 22, and a wireless terminal apparatus 31.

On an enterprise network 10, the enterprise server 11 and the enterprise gateway 12 are provided. The enterprise network 10 is a network for enterprises which manage meters provided on houses or offices, and examples include a network of a gas company. On a wireless access network 20, the base station control device 21 and the wireless base station 22 are provided. Examples of the wireless access network 20 include a network for communication dealers which provide wireless communication service. The wireless access network 20 may be referred to as an ASN (Access Service Network).

The enterprise server 11 is a server device (telemetering server) which collects various types of data from meters provided at houses or offices through telemetering for management. An IP (Internet Protocol) address of the enterprise server 11 is 133.XX.1.50. The enterprise gateway 12 is a gateway device which is connected to the wireless access network 20. The enterprise server 11 communicates with the base station control device 21 through the enterprise gateway 12.

The base station control device 21 is a communication apparatus which manages the wireless base station 22 (and the other wireless base stations in the wireless access network 20), and connected to the enterprise gateway 12. The base station control device 21 may be referred to as an ASN gateway. The base station control device 21 manages a communication state of the wireless terminal apparatus 31 based on the control information received from the wireless base station 22. The base station control device 21 transfers to the enterprise server 11 at least a part of data to be received from the wireless base station 22. An IP address for the base station control device 21 is 130.XX.1.1.

The wireless base station 22 is a wireless communication apparatus which wirelessly communicates with the wireless terminal apparatus 31 (and other wireless terminal apparatus). The wireless base station 22 transfers to the base station control device 21 control data or data received through a wireless link from the wireless terminal apparatus 31. The wireless base station 22 further has a function as a paging controller having a context during an idle mode of the wireless terminal apparatus 31. An IP address of the wireless base station is 130.XX.1.10, and a BS-ID (Base Station Identification) is 0x0A0BXX (namely, 0A0BXX in a hexadecimal notation).

The wireless terminal apparatus 31 is a terminal apparatus (smart meter) which transmits various data including measured data to the enterprise server 11 through wireless communication. The wireless terminal apparatus 31 includes, for example, a module for measuring the use of gas and a module for wirelessly transmitting measured results. The wireless terminal apparatus 31 appropriately switches between the normal mode and the idle mode for operation. Specifically, the wireless terminal apparatus 31 operates in the idle mode during a period at which data is not transmitted and transits to the normal mode when data is transmitted. Note that the wireless terminal apparatus 31 may transmit data as it is in the idle mode. A MAC (Media Access Control) address of the wireless terminal apparatus 31 is 80:00:01:A0:01:XX.

As described above, in the second embodiment, the wireless base station 22 doubles as a paging controller, and further other communication apparatus such as the base station control device 21 may double as a paging controller. A communication apparatus dedicated to a paging controller may be further provided on the wireless access network 20. In the second embodiment, the wireless terminal apparatus 31 has a module for measurement; however, a measuring instrument may be separated from the wireless terminal apparatus 31. In the above description, examples include a module for measuring the use of gas and further a module for measuring the use of electricity or water.

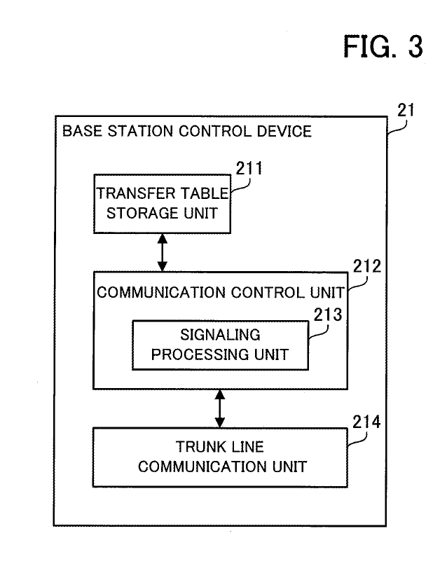

FIG. 3 is a block diagram illustrating the base station control device. The base station control device 21 has a transfer table storage unit 211, a communication control unit 212, a signaling processing unit 213, and a trunk line communication unit 214. The signaling processing unit 213 is provided in the communication control unit 212.

The transfer table storage unit 211 is a storage device (e.g., a memory) which stores a transfer table. The transfer table is a table in which a transfer destination (in the second embodiment, the enterprise server 11) of data and a type of the data to be transferred to the transfer destination are registered. The transfer table is registered through the signaling at the time when the wireless terminal apparatus 31 transits from the normal mode to the idle mode.

The communication control unit 212 controls communication with the wireless terminal apparatus 31 through the wireless base station 22 and communication with the enterprise server 11 through the enterprise gateway 12. For example, when a control message is acquired from the wireless terminal apparatus 31, the communication control unit 212 performs control processing (including a position registration) according to the control message. Suppose further that the communication control unit 212 refers to the transfer table stored in the transfer table storage unit 211 and a type of registered data is included in the control message. In this case, the communication control unit 212 generates a message including the data to a transfer destination (enterprise server 11). When a data message is acquired from the wireless terminal apparatus 31, the communication control unit 212 further performs transfer processing of the data message.

When a signaling request message is acquired from the enterprise server 11, the signaling processing unit 213 performs signaling between the wireless terminal apparatus 31 and its own unit, namely, performs signal control for setting a data transfer method during the idle mode. The signaling is performed at the time when the wireless terminal apparatus 31 transits from the normal mode to the idle mode.

Specifically, when the signaling request message is acquired from the enterprise serve 11, the signaling processing unit 213 generates a control message to the wireless base station 22 including information indicating a type of the data specified by the signaling request message. When the control message as a response is acquired from the wireless base station 22, the signaling processing unit 213 registers an address of the enterprise server 11 and a type of the data specified by the signaling request message in the transfer table stored in the transfer table storage unit 211. The signaling processing unit 213 then generates a signaling response message to the enterprise server 11.

In the second embodiment, a case where a transition to a sleep mode is requested from the side of the wireless access network 20 will be described. In the same manner, also in the case where a transition to the sleep mode is requested from the wireless terminal apparatus 31, the signaling is performed during the transition to the sleep mode. Further, the signaling may be performed at timing different from that of a transition to the sleep mode.

The trunk line communication unit 214 transmits and receives a message to and from the enterprise gateway 12 and the wireless base station 22. Specifically, the trunk line communication unit 214 supplies the control message or data message received from the wireless base station 22 to the communication control unit 212, and transmits the control message generated by the communication control unit 212 to the wireless base station 22. Further, the trunk line communication unit 214 supplies the message received from the enterprise gateway 12 to the communication control unit 212, and transmits to the enterprise gateway 12 a message to the enterprise server 11 generated by the communication control unit 212 or a data message to be transferred.

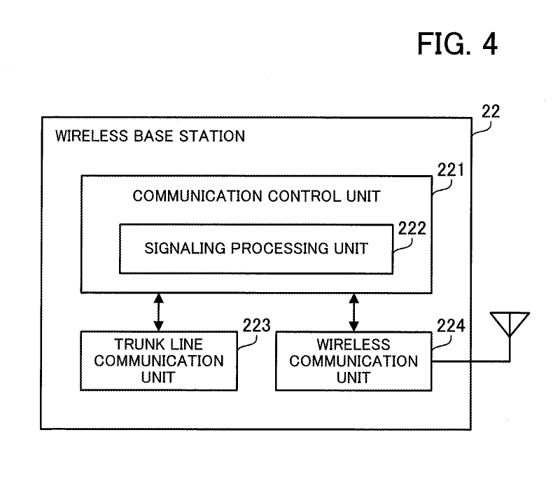

FIG. 4 is a block diagram illustrating the wireless base station. The wireless base station 22 has a communication control unit 221, a signaling processing unit 222, a trunk line communication unit 223, and a wireless communication unit 224. The signaling processing unit 222 is provided in the communication control unit 221.

The communication control unit 221 exchanges a control message with the base station control device 21 and the wireless terminal apparatus 31, and controls communication with the wireless terminal apparatus 31. Suppose, for example, that the communication control unit 221 acquires a control message from the wireless terminal apparatus 31. According to contents of the control message, the communication control unit 221 establishes or disconnects a wireless link and generates the control message to the base station control device 21. When a data message is acquired from the wireless terminal apparatus 31, the communication control unit 221 further performs transfer processing to the base station control device 21.

The signaling processing unit 222 relays signaling between the base station control device 21 and the wireless terminal apparatus 31. The signaling is performed at the time when the wireless terminal apparatus 31 transits from the normal mode to the idle mode. When a control message including signaling information is acquired from the base station control device 21, the signaling processing unit 222 generates a control message to the wireless terminal apparatus 31. When a control message as a response is acquired from the wireless terminal apparatus 31, the signaling processing unit 222 generates a control message to the base station control device 21.

The trunk line communication unit 223 transmits and receives a message to and from the base station control device 21. Specifically, the trunk line communication unit 223 supplies the control message received from the base station control device 21 to the communication control unit 221. The trunk line communication unit 223 further transmits the control message generated or data message transferred by the communication control unit 221 to the base station control device 21.

The wireless communication unit 224 transmits and receives a message to and from the wireless terminal apparatus 31 through a wireless link. Specifically, the wireless communication unit 224 subjects a received signal to wireless signal processing and extracts the control message and data message transmitted by the wireless terminal apparatus 31, thus supplying them to the communication control unit 221. The wireless communication unit 224 converts the control message generated by the communication control unit 221 into a transmission signal and wirelessly outputs it.

In the second embodiment, the wireless base station 22 has no transfer table; however, may have the same transfer table as that of the base station control device 21. In that case, a transfer table may be preferably stored in a storage device (e.g., a memory) included in the wireless base station 22. In place of the base station control device 21, the wireless base station 22 may further determine whether a predetermined type of data is included in the control message transmitted by the wireless terminal apparatus 31. Or, alternatively, both of the base station control device 21 and the wireless base station 22 may determine the above matter.

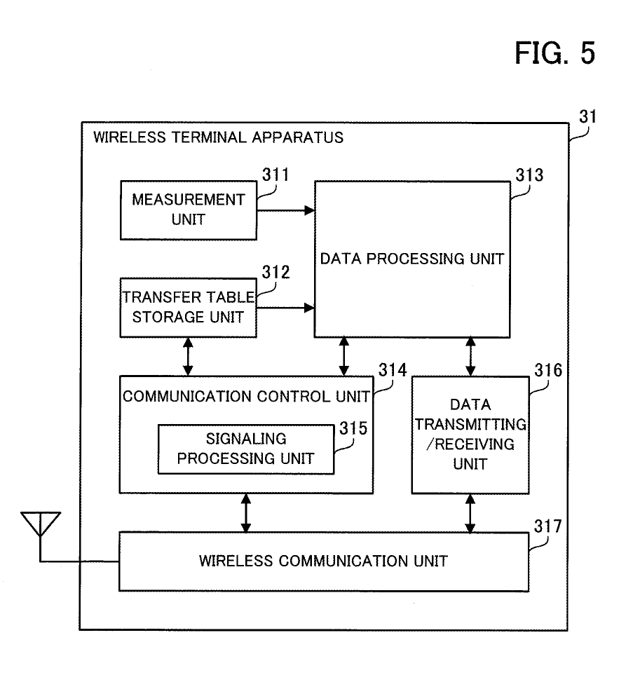

FIG. 5 is a block diagram illustrating the wireless terminal apparatus. The wireless terminal apparatus 31 has a measurement unit 311, a transfer table storage unit 312, a data processing unit 313, a communication control unit 314, a signaling processing unit 315, a data transmitting/receiving unit 316, and a wireless communication unit 317. The signaling processing unit 315 is provided in the communication control unit 314.

The measurement unit 311 is a measurement unit which collects data relating to a monitor object. For example, the measurement unit 311 collects measurement data such as an instantaneous consumption amount and accumulated consumption amount of gas. The collected data will be described in detail below. The measurement unit 311 supplies a part or all of the collected data to the data processing unit 313 according to a request from the data processing unit 313.

The transfer table storage unit 312 is a storage unit (e.g., a memory) which stores a transfer table. In the transfer table, there is registered a type of data capable of being transmitted as it is in the idle mode without the transition to the normal mode. A construction of the transfer table held in the wireless terminal apparatus 31 may be different from that of the base station control device 21. In this transfer table, a type of the data is registered through the signaling at the time when the wireless terminal apparatus 31 transits from the normal mode to the idle mode.

The data processing unit 313 continuously acquires various data from the measurement unit 311 and refers to the transfer table stored in the transfer table storage unit 312, thus controlling data transmission to the enterprise server 11. In the data processing unit 313, timing of acquiring data from the measurement unit 311 is set for each type of data. When the data is acquired at the set timing, based on the information registered in the transfer table and the operation mode of the wireless terminal apparatus 31, the data processing unit 313 selects any of the communication control unit 314 and data transmitting/receiving unit 316 through which the data is transmitted.

Specifically, in the case where the wireless terminal apparatus 31 operates in the normal mode, the data processing unit 313 converts data into a packet format and supplies it to the data transmitting/receiving unit 316. In the case where the wireless terminal apparatus 31 operates in the idle mode and the acquired data is a type of data registered in the transfer table, the data processing unit 313 supplies the data to the communication control unit 314. In the case except the above case, the data processing unit 313 supplies the data packet to the data transmitting/receiving unit 316 and instructs the communication control unit 314 to transit to the normal mode.

The communication control unit 314 controls wireless communication with the wireless base station 22. For example, when a control message is acquired from the wireless base station 22, the communication control unit 314 performs control processing (including establishment and disconnection of the wireless link) according to the control message. The communication control unit 314 further generates a control message to be transmitted to the wireless base station 22. In the generated control message, there are included a message for updating a position registration during the idle mode and a message for reconnecting the wireless terminal apparatus 31 to the wireless access network 20. Into the former message, the data acquired from the data processing unit 313 may be inserted.

The signaling processing unit 315 performs signaling between the base station control device 21 and its own unit. The signaling is performed at the time when the wireless terminal apparatus 31 transits from the normal mode to the idle mode. When a control message including information on the signaling is acquired from the wireless base station 22, the signaling processing unit 315 registers a type of the data specified by the control message in the transfer table stored in the transfer table storage unit 312. The signaling processing unit 315 then generates a control message as a response.

The data transmitting/receiving unit 316 sets a service flow between the wireless access network 20 and its own unit, and controls the transmission and reception of a data message. For example, when a data packet is acquired from the data processing unit 313, the data transmitting/receiving unit 316 generates a data message and supplies it to the wireless communication unit 317.

The wireless communication unit 317 synchronizes the message with a wireless frame transmitted and received by the wireless base station 22, and transmits and receives it through the wireless link. Specifically, the wireless communication unit 317 subjects a received signal from the wireless base station 22 to wireless signal processing and extracts the control message, thus supplying it to the communication control unit 314. The wireless communication unit 317 converts into a transmission signal the control message generated by the communication control unit 314 and the data message generated by the data transmitting/receiving unit 316, and wirelessly outputs them.

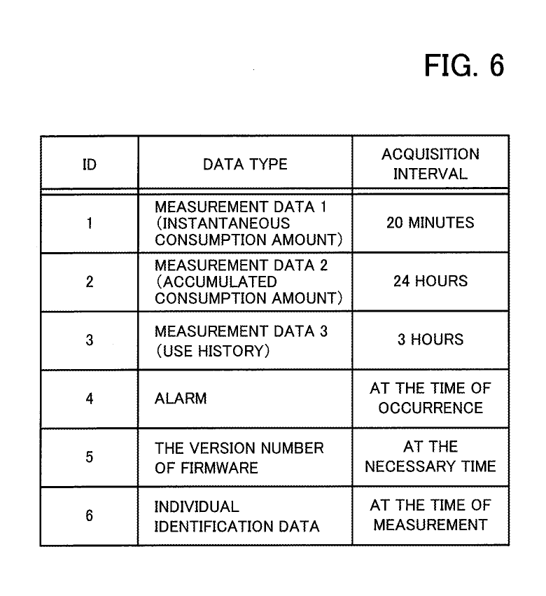

FIG. 6 illustrates a data type of data to be collected. In an example of FIG. 6, six data types are defined. An ID is given to each data type for identification. A relationship between the ID and the data type is previously agreed between the enterprise server 11 and the wireless terminal apparatus 31. Further, in the data processing unit 313 of the wireless terminal apparatus 31, a relationship between the data type and an acquisition interval is previously set. The acquisition interval may be changed.

ID=1 means the instantaneous consumption amount of a monitor object (e.g., gas). The instantaneous consumption amount is acquired every 20 minutes. ID=2 means the accumulated consumption amount of the monitor object. The accumulated consumption amount is acquired every 24 hours. ID=3 means a use history of the monitor object. In the use history, various types of statistical information such as what time gas is used at are included. The use history is acquired every three hours.

ID=4 means an alarm. The alarm is acquired as soon as abnormality is detected by the measurement unit 311. ID=5 means the version number of firmware for managing use conditions of the monitor object. The version number of the firmware is acquired if necessary (for example, at the time when it is acquired from the enterprise server 11). ID=6 means individual identification data for each identifying a smart meter. The individual identification data is acquired in conformity with the measurement data of the ID=1 to 3.

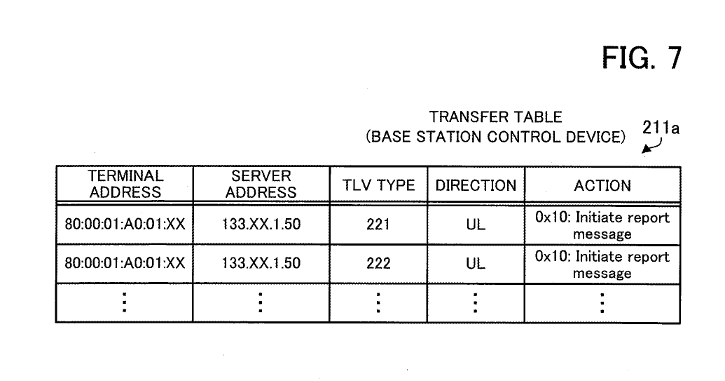

FIG. 7 illustrates an example of the transfer table (base station control device). In the transfer table 211a, a method for transferring data from the wireless terminal apparatus 31 to the enterprise server 11 is registered. Further, in the transfer table 211a, a method for transferring control data from the enterprise server to the wireless terminal apparatus 31 is also registered. The transfer table 211a is stored in the transfer table storage unit 211 of the base station control device 21. The transfer table 211a includes items of a terminal address, a server address, a TLV (Type Length Value) type, a direction, and an action.

In the column of the terminal address, a MAC address of the wireless terminal apparatus 31 (or, another wireless terminal apparatus) is described. In the column of the server address, an IP address of the enterprise server 11 (or, another server device) is described. In the column of the TLV type, a value indicating a type of TLV is set. The TLV is variable-length data represented by a combination of (type, length, and value), and may be included in a message received by the base station control device 21. In the following description relating to the TLV, descriptions may be omitted with regard to a “type” of one byte and a “length” of one byte.

In the column of the direction, UL or DL is described as a transmission direction of the message. The UL means a direction from the wireless terminal apparatus to the enterprise server 11, and the DL means a direction from the enterprise server 11 to the wireless terminal apparatus 31. Accordingly, in the case of the direction=the UL, a terminal address means a transmission source address, and a server address means a destination address. In the case of the direction=the DL, the terminal address means the destination address, and the server address means the transmission source address.

In the column of the action, there is described a value indicating a process performed at the time when the base station control device 21 receives a message adapted to a condition of (terminal address, server address, TLV type, and direction). The action=0x10 means that a report message to the server device is generated and transmitted. For example, a record having the TLV type=221, the direction=UL, and the action=0x10 means that when a control message including a TLV of the TLV type=221 is received from the wireless terminal apparatus 31, a report message including contents of the TLV is generated and transmitted to the enterprise server 11.

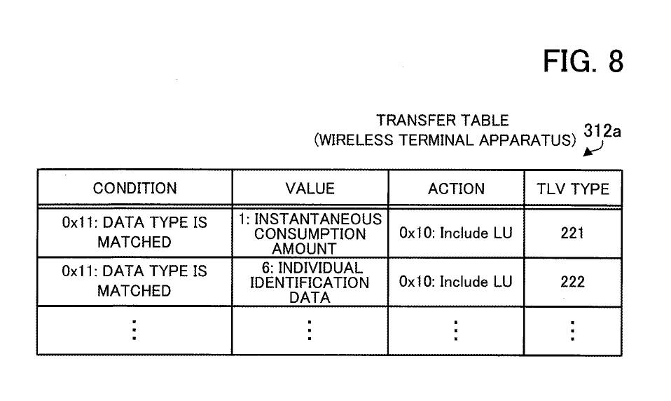

FIG. 8 illustrates an example of the transfer table (wireless terminal apparatus). In the transfer table 312a, there is registered a method for transferring data from the wireless terminal apparatus 31 to the enterprise server 11. The transfer table 312a is stored in the transfer table storage unit 312 of the wireless terminal apparatus 31. The transfer table 312a includes the items of conditions, values, actions, and TLV types.

In the column of the condition, a value indicating a type of condition determination is described. The condition=0x11 means conditions in which a data type of data to be transmitted is matched with the data type described in the column of the value. In the column of the value, a parameter used in the condition determination is described. In the case where the parameter is a data type, the ID (1 to 6) of the data type is described.

In the column of the action, there is described a value indicating a process performed at the time when the wireless terminal apparatus 31 transmits data adapted to (conditions and values). The action=0x10 means that data is included in the control message (RNG-REQ message) to be transmitted at the time of a process (LU: Location Update) for updating a position registration of the wireless terminal apparatus 31, and transmitted. In the column of the TLV type, a value indicating a type of the TLV is described. The wireless terminal apparatus 31 inserts data into the control message as the TLV specified by the TLV type.

For example, a record having the condition=0x11, the value=1, the action=0x10, and the TLV type=221 means that in the case where the wireless terminal apparatus 31 transmits data of the instantaneous consumption amount, the data is included in the RNG-REQ message as a TLV of the TLV type=221, and transmitted. Further, a record having the condition=0x11, the value=6, the action=0x10, and the TLV type=222 means that in the case where data of the individual identification data is transmitted, the data is included in the RNG-REQ message as a TLV of the TLV type=222, and transmitted.

The TLV type used for data transmission from the wireless terminal apparatus 31 to the base station control device 21 may be specified by the base station control device 21 at the time of the transition to a sleep mode, or previously determined fixedly. In the following description, the base station control device 21 is supposed to specify the TLV type. Or, in the case where the TLV type is not specified, 0 may be described in the column of the TLV type. On the determination condition whether to include data in the control message and transmit the data, conditions relating to the data size may be provided.

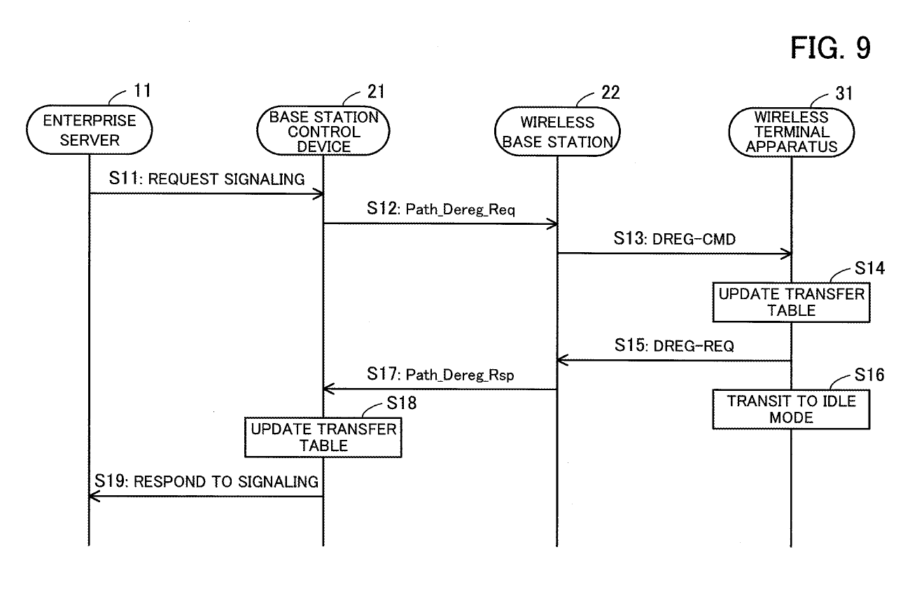

FIG. 9 is a sequence diagram illustrating a flow of data transfer setting. FIG. 9 illustrates a procedure at the time when the wireless terminal apparatus 31 transits from the normal mode to the sleep mode.

(Step S11) The enterprise server 11 transmits to the base station control device 21a signaling request message representing a request of the signaling for the wireless terminal apparatus 31. In the signaling request message, there is included information on a type of data capable of being included in the control message and transmitted during the idle mode by the wireless terminal apparatus 31.

(Step S12) When the signaling request message is received from the enterprise server 11 at the time when the wireless terminal apparatus 31 operates in the normal mode, the base station control device 21 transmits a Path_Dereg_Req message as a control message to the wireless base station 22. The Path_Dereg_Req message allows the wireless terminal apparatus 31 to transit to the idle mode. Into the Path_Dereg_Req message, the TLV corresponding to contents of the signaling request message is inserted.

(Step S13) When the Path_Dereg_Req message is received from the base station control device 21, the wireless base station 22 transmits a DREG-CMD message as a control message to the wireless terminal apparatus 31. The DREG-CMD message instructs the wireless terminal apparatus 31 to release the connection and transit to the idle mode. Into the DREG-CMD message, a TLV corresponding to the TLV of the Path_Dereg_Req message is inserted.

(Step S14) When the DREG-CMD message is received from the wireless base station 22, the wireless terminal apparatus 31 registers contents of the TLV included in the DREG-CMD message in the transfer table 312a.

(Step S15) As a response to the DREG-CMD message, the wireless terminal apparatus 31 transmits the DREG-REQ message as a control message to the wireless base station 22. Into the DREG-REQ message, a TLV corresponding to the TLV of the DREG-CMD message is inserted for confirmation.

(Step S16) The wireless terminal apparatus 31 transits from the normal mode to the idle mode. Specifically, the wireless communication unit 317 of the wireless terminal apparatus 31 repeats in a predetermined period an Unavailable section in which transmission and reception of wireless signals is stopped and an Available section in which transmission and reception of wireless signals is performed. As a stoppage of the transmission and reception, there is considered a process such as a power supply of the wireless communication unit 317 is stopped or a clock frequency is reduced. Note that a process of step S16 is not necessarily performed in advance of the following processes of steps S17 to S19.

(Step S17) When the DREG-REQ message is received from the wireless terminal apparatus 31, the wireless base station 22 transmits a Path_Dereg_Rsp message as a control message to the base station control device 21. Into the Path_Dereg_Rsp message, a TLV corresponding to the TLV of the DREG-REQ message is inserted.

(Step S18) When the Path_Dereg_Rsp message is received from the wireless base station 22, the base station control device 21 registers contents (or, contents of the signaling request message received at step S12) of the TLV included in the Path_Dereg_Rsp message in the transfer table 211a. Note that a process of step S18 may be performed posterior to the following process of step S19.

(Step S19) As a response to the signaling request message received at step S12, the base station control device 21 transmits a signaling response message to the enterprise server 11. Into the signaling response message, information corresponding to the TLV of the Path_Dereg_Rsp message is inserted for confirmation.

As can be seen from the above sequence, the base station control device 21 performs signaling between the wireless terminal apparatus 31 and its own device through the wireless base station 22. Through the process, a type of data capable of being included in the control message and transmitted during the idle mode is registered in the transfer table 211a of the base station control device 21 and the transfer table 312a of the wireless terminal apparatus 31. The control message used in the signaling is one example, and other types of the control messages may be used. When performing the signaling once, the wireless terminal apparatus 31 eliminates the need to perform the signaling for each transition to the idle mode.

In FIG. 9, an example where the signaling is performed at the time when the wireless terminal apparatus 31 transits to the idle mode is illustrated; further, the signaling may be performed during the idle mode. For example, when the enterprise server 11 transmits the signaling request message during the idle mode, the base station control device 21 includes information on the signaling in a Paging_Announce message, and transmits it. The wireless base station 22 includes the information on the signaling in a paging message (MOB_PAG-ADV message) representing a request of an LU, and broadcasts it. The wireless terminal apparatus 31 includes a signaling response in the RNG-REQ message and transmits it to the wireless base station 22.

In second signaling or later (including both the signaling at the time of the transition to the idle mode and the signaling during the idle mode), a type of data is added, and further a type of the data specified by past signaling is changed or deleted.

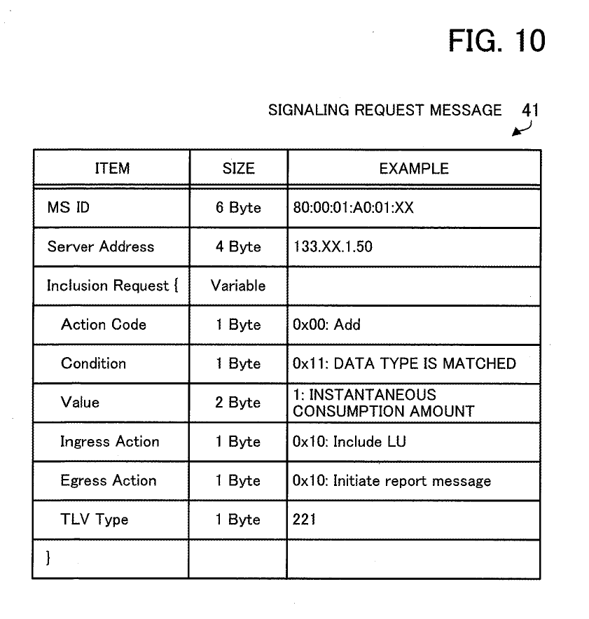

FIG. 10 illustrates an example of the signaling request message. The signaling request message 41 is the message transmitted at the step S11. The signaling request message 41 includes an MSID (6 bytes), a Server Address (4 bytes), and one or more Inclusion Requests.

The MSID is a MAC address of a wireless terminal apparatus (wireless terminal apparatus 31) of the signaling objects. The Server Address is an IP address of a transmission source (enterprise server 11) of the signaling request message 41. The Inclusion Request is information in which a data transfer method during the idle mode is specified. The Inclusion Request each includes an Action Code (1 byte), a Condition (1 byte), a Value (2 bytes), an Ingress Action (1 byte), an Egress Action (1 byte), and a TLV Type (1 byte).

The Action Code is a value indicating operations to be requested to the base station control device 21. For example, 0x00 means Add (addition to a transfer table), 0x01 means Del (deletion from a transfer table), and 0x02 means Flash & Add (overwriting of the contents registered in a transfer table). The Condition corresponds to “conditions” of the transfer table 312a. For example, 0x01 means that a data type of a downlink (DL) is matched with the Value, 0x02 means that a DL communication port number is matched with the Value, and 0x03 means that the TLV of the DL is matched with the Value. Further, 0x11 means that a data type of the uplink (UL) is matched with the Value, and 0x12 means that a UL communication port number is matched with the Value. The Value corresponds to a “value” of the transfer table 312a.

The Ingress Action is a value indicating operations to be requested to a transmission source (the base station control device 21 in the DL, and the wireless terminal apparatus 31 in the UL) of the control message. For example, 0x01 means that a TLV is included in a DL control message, and 0x02 means that DL received data is transferred without performing conversion of a data format (DL pass-through). Further, 0x10 means that a TLV is included in an RNG-REQ message, and 0x11 means a UL pass-through.

The Egress Action is a value indicating operations to be requested to a destination (the wireless terminal apparatus 31 in the DL, and the base station control device 21 in the UL) of the control message. For example, 0x00 means a report of the held data, 0x01 means that a DL received TLV is notified an upper layer, and 0x02 means a DL pass-through. Further, 0x10 means generation of a UL report message, and 0x11 means a UL pass-through. The TLV Type corresponds to “TLV types” of the transfer table 211a and the transfer table 312a.

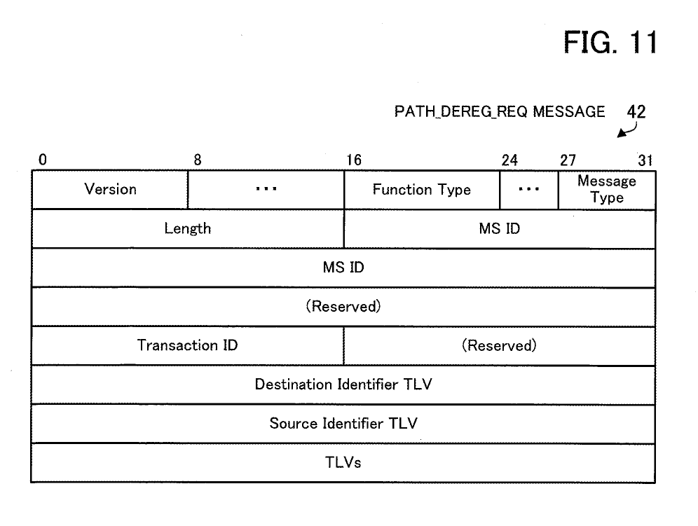

FIG. 11 is a first diagram illustrating an example of the Path_Dereg_Req message. The Path_Dereg_Req message 42 is the message transmitted at the step S12. The Path_Dereg_Req message 42 includes a Version (1 byte), a Function Type (1 byte), a Message Type (5 bits), a Length (2 bytes), an MSID (6 bytes), a Transaction ID (2 bytes), a Destination Identifier TLV (4 bytes), and a Source Identifier TLV (4 bytes).

The Version represents the version number of the Path_Dereg_Req message 42 and, for example, is set to 0x01. The Function Type and the Message Type each indicate a function and type of the Path_Dereg_Req message 42 and, for example, the Function Type is set to 3 and the Message Type is set to 2. The Length indicates lengths of subsequent message fields. The MSID indicates a MAC address (80:00:01:A0:01:XX) of the wireless terminal apparatus 31. The Transaction ID indicates a number identifying a transaction between the base station control device 21 and the wireless base station 22. The Destination Identifier TLV indicates a destination IP address (130.XX.1.10), and the Source Identifier TLV indicates a transmission source IP address (130.XX.1.1).

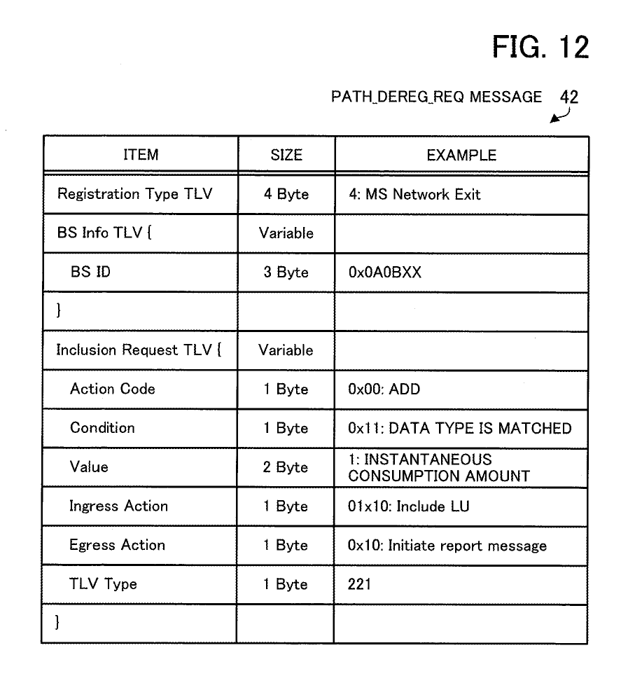

FIG. 12 is a second diagram illustrating an example of the Path_Dereg_Req message. The information illustrated in FIG. 12 is inserted into the column of the “TLVs” of FIG. 11. The Path_Dereg_Req message 42 includes a Registration Type TLV (4 bytes), one or more BS Info TLVs, and one or more Inclusion Request TLVs.

The Registration Type TLV is a value indicating operations to be requested to the wireless base station 22 and the wireless terminal apparatus 31. For example, the type=4 means a release of the connection between the wireless access network 20 and the wireless terminal apparatus 31. The BS Info TLV includes a BSID (3 bytes). The BSID indicates an ID of a wireless base station for performing the operations specified by the Registration Type TLV. The Inclusion Request TLV corresponds to the Inclusion Request included in the signaling request message 41.

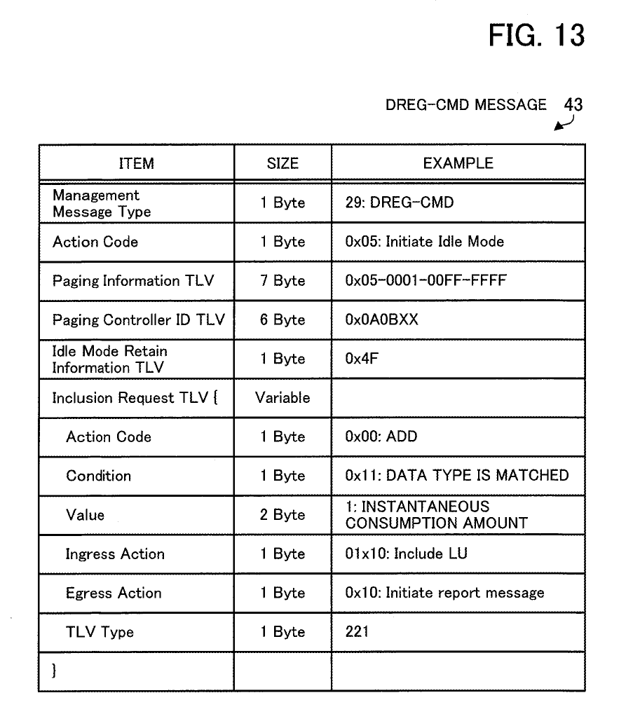

FIG. 13 illustrates an example of the DREG-CMD message. The DREG-CMD message 43 is the message transmitted at the step S13. The DREG-CMD message 43 includes a Management Message Type (1 byte), an Action Code (1 byte), a Paging Information TLV (7 bytes), a Paging Controller ID TLV (6 bytes), an Idle Mode Retain Information TLV (1 byte), and one or more Inclusion Request TLVs.

The Management Message Type is a value indicating a type of the control message, and set to the type=29. The action code is a value indicating operations performed by the wireless terminal apparatus 31. For example, 0x05 means the transition to the idle mode. The Paging Information TLV is a value indicating operations during the idle mode of the wireless terminal apparatus 31. For example, a period (the number of wireless frames) at which a paging message is received, an offset (wireless frame number), and a value indicating a paging group are set. The paging group is a group obtained by classifying wireless terminal apparatus so as to effectively determine the presence or absence of the paging.

The Paging Controller ID TLV indicates an address of a device which holds connection information (context) during the idle mode. In the second embodiment, the paging controller ID TLV is set to the ID (0x0A0 BXX) of the wireless base station 22. The Idle Mode Retain Information TLV is information indicating a context column to be held during the idle mode. The Inclusion Request TLV corresponds to the Inclusion Request TLV included in the Path_Dereg_Req message 42.

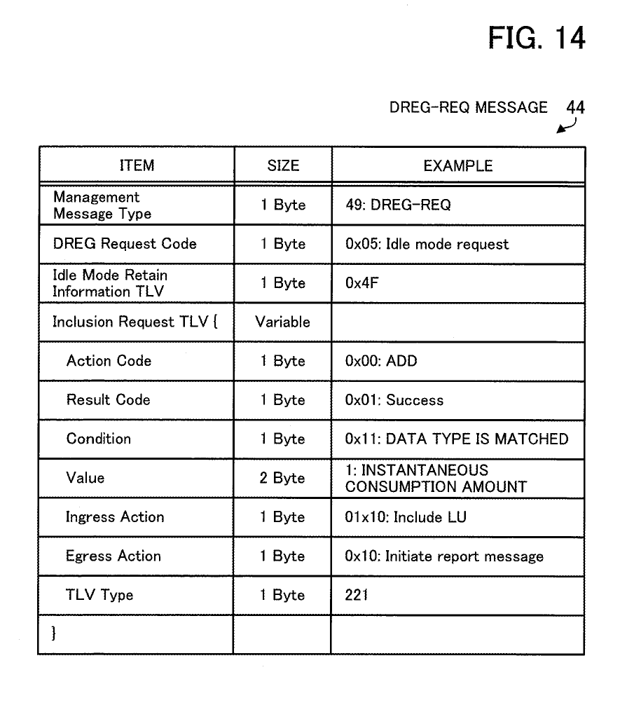

FIG. 14 illustrates an example of the DREG-REQ message. The DREG-REQ message 44 is the message transmitted at the step S15. The DREG-REQ message 44 includes a Management Message Type (1 byte), a DREG Request Code (1 byte), an Idle Mode Retain Information TLV (1 byte), and one or more Inclusion Request TLVs.

The Management Message Type is a value indicating a type of the control message, and set to the type=49. The DREG request code is a value indicating a cause for releasing the connection between the wireless terminal apparatus 31 and the wireless access network 20. For example, 0x05 means that the wireless base station 22 requests a transition to the idle mode.

The Idle Mode Retain Information TLV corresponds to the Idle Mode Retain Information TLV included in the DREG-CMD message 43. The Inclusion Request TLV corresponds to an Inclusion Request TLV obtained by adding a Result Code (1 byte) to the Inclusion Request TLV included in the DREG-CMD message 43. The Result Code is a value indicating a success and failure in a registration to the transfer table 312a, and 0x00 means a failure and 0x01 means a success.

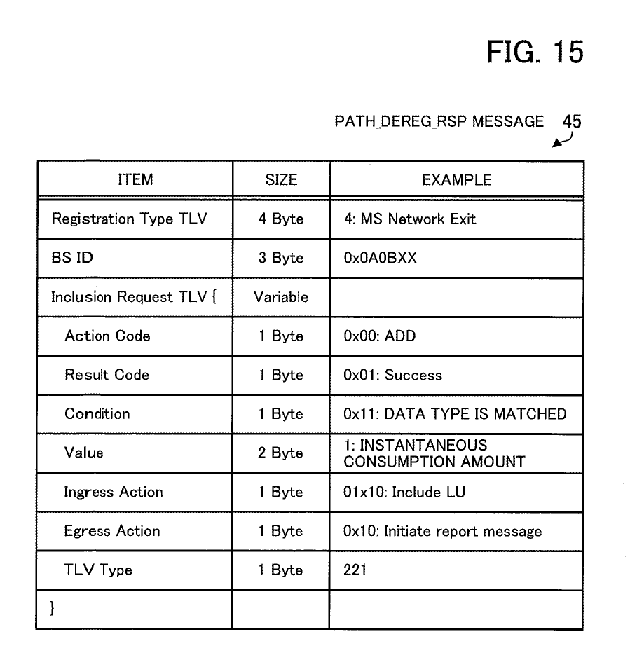

FIG. 15 illustrates an example of the Path_Dereg_Rsp message. The Path_Dereg_Rsp message 45 is the message transmitted at the step S17. The Path_Dereg_Rsp message 45 includes a Registration Type VLD (4 bytes), a BSID (3 bytes), and one or more Inclusion Request TLVs.

The Registration Type TLV is a value indicating a reason in which the wireless terminal apparatus 31 which transmits the DREG-REQ message 44 performs a release of the connection. In the second embodiment, since the release of the connection is requested by the Path_Dereg_Req message 42, the Registration Type TLV is set to the type=4 in the same manner as in the Path_Dereg_Req message 42. The BSID is an ID (0x0A0BXX) of the wireless base station 22 which performs the release of the connection to the wireless terminal apparatus 31. The Inclusion Request TLV corresponds to the Inclusion Request TLV included in the DREG-REQ message 44.

A format of a header portion of the Path_Dereg_Rsp message 45 is the same as that of the Path_Dereg_Req message 42 illustrated in FIG. 11. In this case, the Function Type is set to 3, and the Message Type is set to 3. The Destination Identifier TLV is set to an IP address (130.XX.1.1) of the base station control device 21 as a destination of the Path_Dereg_Rsp message 45. The Source Identifier TLV is set to an IP address (130.XX.1.10) of the wireless base station 22 as a transmission source.

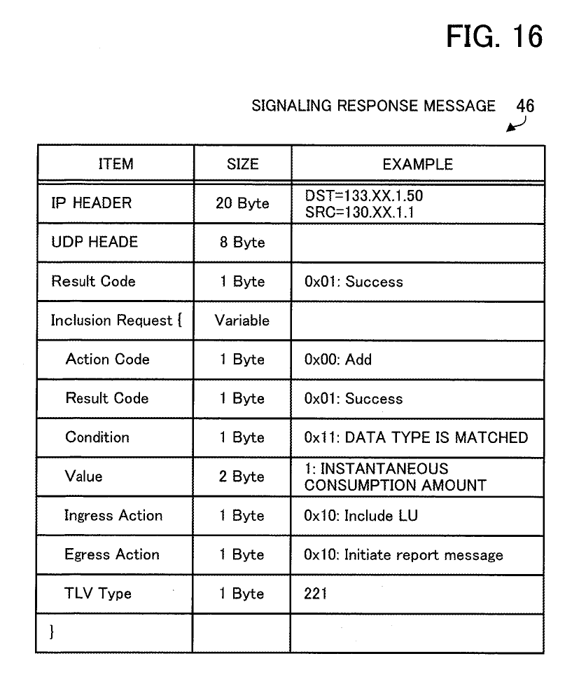

FIG. 16 illustrates an example of the signaling response message. The signaling response message 46 is the message transmitted at the step S19. The signaling response message 46 is transmitted by using a UDP/IP. The signaling response message 46 includes an IP header (20 bytes), a UDP header (8 bytes), and a Result Code (1 byte), and zero or more Inclusion Requests.

The Result Code is a value indicating success and failure of the signaling, and 0x00 means a failure and 0x01 means a success. In the case where the Path_Dereg_Rsp message 45 is not received within a predetermined time after transmitting the Path_Dereg_Req message 42, the base station control device 21 considers the above state as a failure of the signaling and transmits the signaling response message 46 to the enterprise server 11. In the case where the signaling fails, the Inclusion Request is not included in the signaling response message 46.

The Inclusion Request corresponds to the Inclusion Request TLV included in the Path_Dereg_Rsp message 45. Note that in the signaling response message 46, only the Inclusion Request which succeeds in the registration in the transfer table 211a and the transfer table 312a is included.

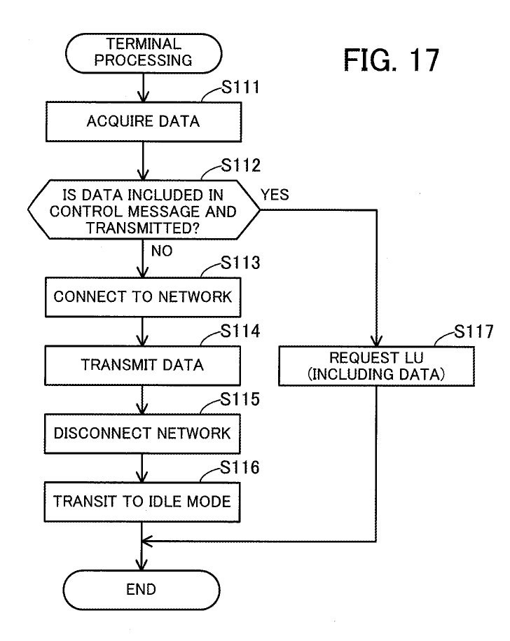

FIG. 17 is a flowchart illustrating terminal processing according to the second embodiment. The wireless terminal apparatus 31 operating in the idle mode performs processes illustrated in FIG. 17.

(Step S111) The data processing unit 313 acquires data from the measurement unit 311. The data processing unit 313 acquires various data such as the instantaneous consumption amount, for example, at the timing illustrated in FIG. 6.

(Step S112) The data processing unit 313 refers to the transfer table 312a stored in the transfer table storage unit 312, and determines whether the data acquired at step S111 is data included in the control message and transmitted. Specifically, the data processing unit 313 determines whether the acquired data is adapted to any of the records (conditions and values) registered in the transfer table 312a. If so, the process advances to step S117. If not, the process proceeds to step S113.

(Step S113) The communication control unit 314 is reconnected to the wireless access network 20 through the wireless communication unit 317. For establishment of the connection, the context held in the wireless base station 22 is used. The process permits the wireless terminal apparatus 31 to return to the normal mode from the idle mode.

(Step S114) The data transmitting/receiving unit 316 generates a data message including the data acquired at step S111. The data transmitting/receiving unit 316 then transmits the data message to the wireless base station 22 through the wireless communication unit 317.

(Step S115) The communication control unit 314 performs a procedure of releasing the connection to the wireless access network 20 through the wireless communication unit 317. The context is stored in the wireless base station 22 during the release of the connection.

(Step S116) The wireless terminal apparatus 31 transits from the normal mode to the idle mode again. Specifically, the wireless communication unit 317 receives a MOB_PAG-ADV message at the period and timing specified by the DREG-CMD message 43, and repeats an operation of stopping transmitting and receiving processing except for the above-described time. The communication control unit 314 determines the presence or absence of a call to its own apparatus based on the periodically received MOB_PAG-ADV message.

(Step S117) The communication control unit 314 generates a RNG-REQ message representing a request of the Location Update. Into the RNG-REQ message, the communication control unit 314 inserts as a TLV the data acquired at step S111. As a TLV type, the TLV type registered in the transfer table 312a is used. The communication control unit 314 then transmits the RNG-REQ message through the wireless communication unit 317 in accordance with the next Available section (section in which the transmitting and receiving processing is performed).

As can be seen from the above description, with respect to a type of the data specified by the enterprise server 11, the wireless terminal apparatus 31 is not reconnected to the wireless access network 20, and includes the above data in a RNG-REQ message to be transmitted next and transmits the data. In the case where a plurality of types of data are acquired, only when all the data are adapted to any of the records (conditions and values) registered in the transfer table 312a, the wireless terminal apparatus 31 may include the above data in the RNG-REQ message and transmit the data. That is, in the case where data preferably included in the RNG-REQ message and transmitted and data different from the above data are mixedly present, the wireless terminal apparatus 31 may collect all of the acquired data and transmit them as a data message.

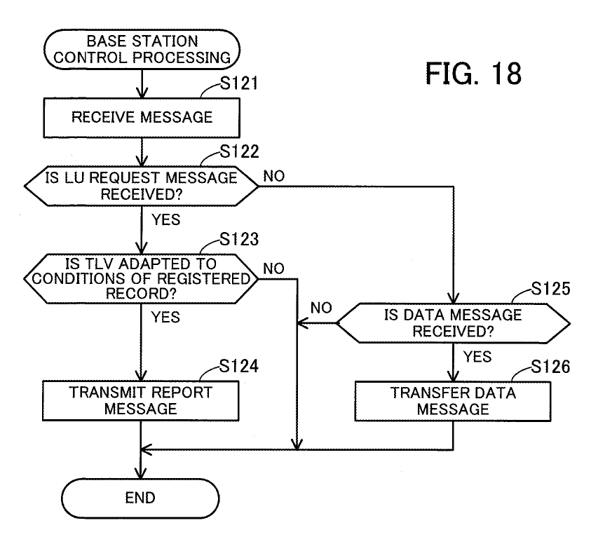

FIG. 18 is a flowchart illustrating the base station control processing according to the second embodiment. When the wireless terminal apparatus 31 operates in the idle mode, the base station control device 21 performs a process illustrated in FIG. 18.

(Step S121) The communication control unit 212 receives a message from the wireless base station 22 through the trunk line communication unit 214.

(Step S122) The communication control unit 212 determines whether the message received at step S121 is an LU_Req message representing a request of the Location Update. If so, the process advances to step S123. If not, the process proceeds to step S125.

(Step S123) The communication control unit 212 refers to the transfer table 211a stored in the transfer table storage unit 211, and determines whether data to be transferred to the enterprise server 11 is included in the LU_Req messages received at step S121. Specifically, the communication control unit 212 determines whether the TLV included in the LU_Req messages is adapted to the conditions indicated by any of the records registered in the transfer table 211a. If so, the process advances to step S124. If not, the process ends.

(Step S124) The communication control unit 212 generates a report message including data inserted into the LU_Req message as a TLV. The communication control unit 212 then transmits the report message to the enterprise server 11 through the trunk line communication unit 214.

(Step S125) The communication control unit 212 determines whether the message received at step S121 is a data message to the enterprise server 11. If so, the process advances to step S126. If not, the process ends.

(Step S126) The communication control unit 212 transfers the data message to the enterprise server 11 through the trunk line communication unit 214.

As can be seen from the above description, in the case where a type of the data specified by the enterprise server 11 is included in the LU_Req message as a control message, the base station control device 21 extracts data and transfers it to the enterprise server 11. In the above description, a method for transferring the data transmitted by the wireless terminal apparatus 31 is mainly described. The base station control device 21 which receives the LU_Req message performs the Location Update (update of position registration) of the wireless terminal apparatus 31.

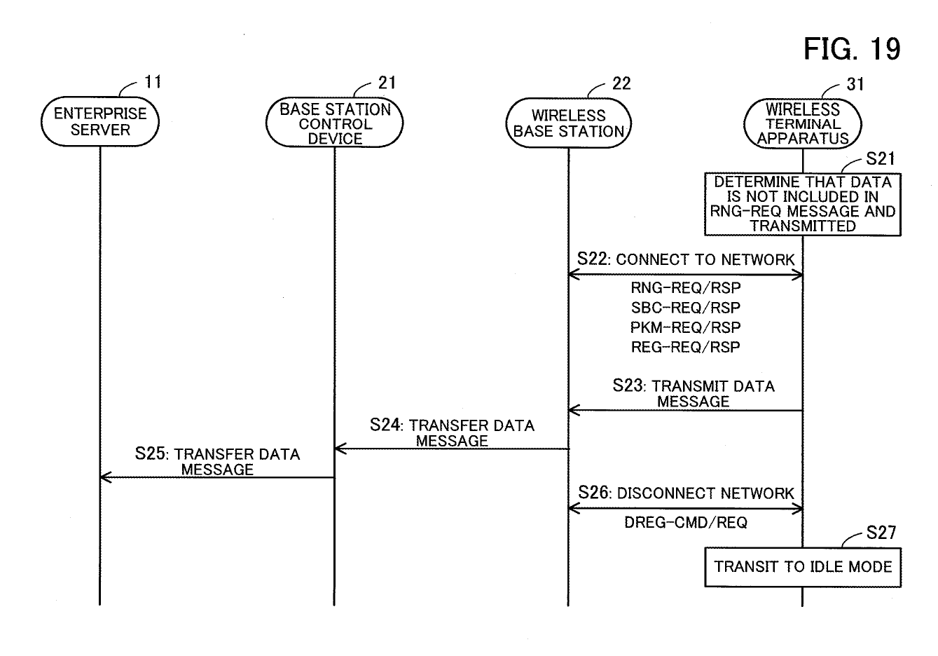

FIG. 19 is a sequence diagram illustrating a flow of a first data transfer according to the second embodiment. A sequence example of FIG. 19 illustrates a case where the data is included in the data message and transmitted.

(Step S21) The wireless terminal apparatus 31 refers to the transfer table 312a and determines that the acquired data is not included in the RNG-REQ message and transmitted.

(Step S22) The wireless terminal apparatus 31 performs a procedure of the reconnection to the wireless access network 20 between the wireless base station 22 and its own apparatus. Specifically, the wireless terminal apparatus 31 transmits the RNG-REQ message, the SBC-REQ message, the PKM-REQ message, and the REG-REQ message in sequence. As a response of the received messages, the wireless base station 22 transmits the RNG-RSP message, the SBC-RSP message, the PKM-RSP message, and the REG-RSP message in sequence, respectively. As a result, the wireless terminal apparatus 31 operates in the normal mode.

(Step S23) The wireless terminal apparatus 31 transmits a data message to the enterprise server 11 to the wireless base station 22.

(Step S24) The wireless base station 22 transfers the data message received from the wireless terminal apparatus 31 to the base station control device 21.

(Step S25) The base station control device 21 transfers the data message received from the wireless base station 22 to the enterprise server 11 through the enterprise gateway 12.

(Step S26) When the transmission of the data is finished, the wireless terminal apparatus 31 performs a procedure of releasing the connection to the wireless access network 20 between the wireless base station 22 and its own apparatus. Specifically, the wireless terminal apparatus 31 transmits the DREG-REQ message to the wireless base station 22. The wireless base station 22 transmits the DREG-CMD message to the wireless terminal apparatus 31.

(Step S27) The wireless terminal apparatus 31 operates in the idle mode. Processes of steps S24 and S25 on the side of the wireless access network 20 and those of steps S26 and S27 on the side of the wireless terminal apparatus 31 are performed in parallel with each other.

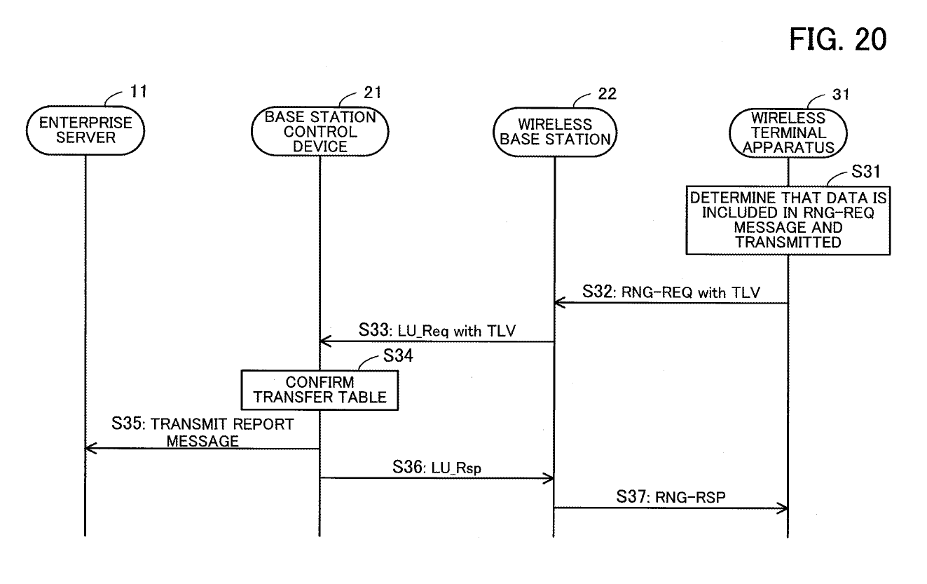

FIG. 20 is a sequence diagram illustrating a flow of a second data transfer according to the second embodiment. A sequence example of FIG. 20 illustrates a case where the data is included in the control message and transmitted.

(Step S31) The wireless terminal apparatus 31 refers to the transfer table 312a and determines that the acquired data is included in the RNG-REQ message and transmitted.

(Step S32) At the timing of performing the Location Update next, the wireless terminal apparatus 31 includes the acquired data in the RNG-REQ message as a TLV and transmits the data to the wireless base station 22. The wireless terminal apparatus 31 transmits the RNG-REQ message as it is in the idle mode (without the procedure of the reconnection to the wireless access network 20).

(Step S33) The wireless base station 22 includes the TLV inserted into the RNG-REQ message received from the wireless terminal apparatus 31 in the LU_Req message and transmits the TLV to the base station control device 21. Specifically, the wireless base station 22 switches the TLV transmitted by the wireless terminal apparatus 31 from the RNG-REQ message to the LU_Req message.

(Step S34) The base station control device 21 confirms the transfer table 211a, and extracts data to be transferred to the enterprise server 11 from the LU_Req message received from the wireless base station 22.

(Step S35) The base station control device 21 transmits a report message including the data extracted at step S34 to the enterprise server 11 through the enterprise gateway 12.

(Step S36) As a response to the LU_Req message, the base station control device 21 transmits the LU_Rsp message to the wireless base station 22.

(Step S37) As a response to the RNG-REQ message, the wireless base station 22 transmits the RNG-RSP message to the wireless terminal apparatus 31. Processes of steps S34 and S35 and those of steps S36 and S37 are performed in parallel with each other.

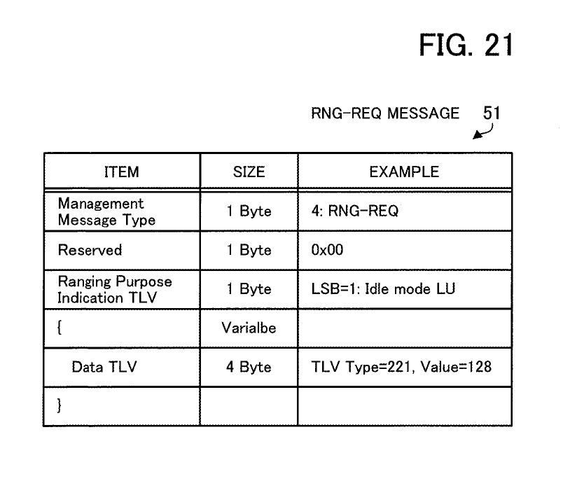

FIG. 21 illustrates an example of the RNG-REQ message. The RNG-REQ message 51 is the message transmitted at step S32. The RNG-REQ message 51 includes a Management Message Type (1 byte), a Ranging Purpose Indication TLV (1 byte), and one or more Data TLVs (4 bytes each).

The Management Message Type is a value indicating a type of the control message, and set to the type=4. The Ranging Purpose Indication TLV is a value indicating a purpose where the wireless terminal apparatus 31 transmits the RNG-REQ message 51. In a request of the Location Update, a lowermost bit is set to 1. The Data TLV includes the TLV type specified by the signaling and the data reported to the enterprise server 11. For example, in the case where the record illustrated in FIG. 8 is registered in the transfer table 312a, the TLV type=221 and the data=128 mean that a value of the instantaneous consumption amount is equal to 128.

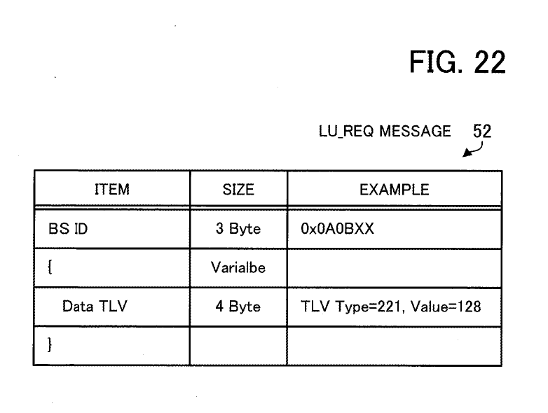

FIG. 22 illustrates an example of the LU_Req message. The LU_Req message 52 is the message transmitted at step S33. The LU_Req message 52 includes a BSID (3 bytes) and one or more Data TLVs (4 bytes each). The BSID indicates an ID (0x0A0BXX) of the wireless base station 22. The Data TLV corresponds to the Data TLV included in the RNG-REQ message 51.

A format of a header portion of the LU_Req message 52 is the same as that of the Path_Dereg_Req message 42 illustrated in FIG. 11. In this case, the Function Type is set to 6, and the Message Type is set to 4. The Destination Identifier TLV is set to an IP address (130.XX.1.1) of the base station control device 21 as a destination of the LU_Req message 52. The Source Identifier TLV is set to an IP address (130.XX.1.10) of the wireless base station 22 as a transmission source.

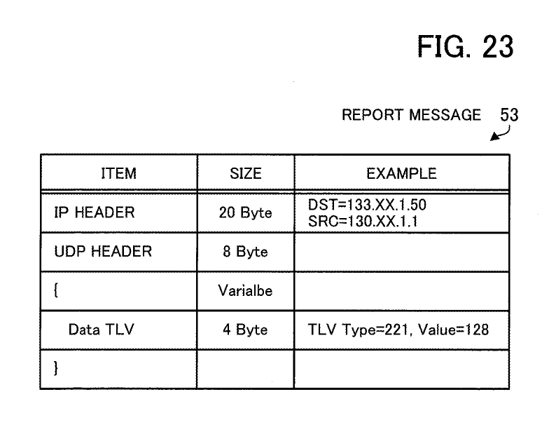

FIG. 23 illustrates an example of the report message. The report message 53 is the message transmitted at step S35. The report message 53 is transmitted by using the UDP and IP. The report message 53 includes an IP header (20 bytes), a UDP header (8 bytes), and one or more Data TLVs (4 bytes each). The Data TLV corresponds to the Data TLV included in the LU_Req message 52.

According to the second embodiment, the proposed wireless communication system permits the wireless terminal apparatus 31 to transmit data to the enterprise server 11 as it is in the idle mode without performing a procedure of the reconnection to the wireless access network 20. Through the process, the wireless terminal apparatus 31 avoids a procedure of the connection and release for the one-time data transmission and suppresses consumption of radio resources, thereby suppressing power consumption of the wireless terminal apparatus 31. In addition, when establishment of the connection between the wireless terminal apparatus 31 and the wireless base station 22 is suppressed, the wireless base station 22 more accommodates wireless terminal apparatus.

Accordingly, the wireless terminal apparatus 31 efficiently transmits data to the enterprise server 11. In particular, for the purpose of transmitting data having a relatively small size intermittently generated, use of the control message to be transmitted during the idle mode is excellent in terms of the transmission efficiency of data. In the second embodiment, a type of the data included in the control message and transmitted is set through the signaling, and may be previously determined statically. In that case, the wireless communication system may eliminate the need to perform the signaling between the base station control device 21 and the wireless terminal apparatus 31.

### Third Embodiment

Next, a third embodiment will be described. Since the third embodiment shares some elements with the foregoing second embodiment, the following discussion will focus on their distinctive points, omitting explanations of similar elements. In a wireless communication system according to the third embodiment, a wireless terminal apparatus receives an apparent request from an enterprise server during an idle mode and transmits data. The wireless communication system according to the third embodiment is implemented by using the same configuration as that of the wireless communication system according to the second embodiment illustrated in FIGS. 2 to 5. The third embodiment will be described below by using the same reference numerals as in FIGS. 2 to 5.

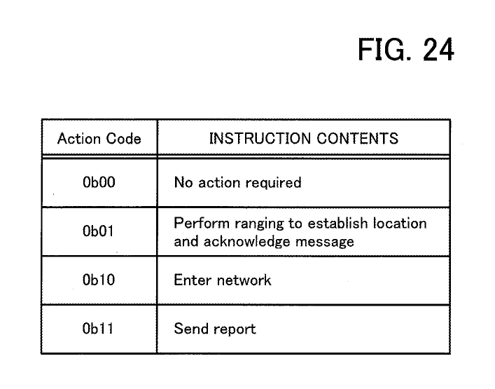

FIG. 24 illustrates an operation instruction to the wireless terminal apparatus. As described in the second embodiment, when the wireless terminal apparatus 31 operates in the idle mode, the wireless base station 22 periodically broadcasts a paging message (MOB_PAG-ADV message). In the MOB_PAG-ADV message according to the third embodiment, any of four Action Codes (2 bits) are included as illustrated in FIG. 24.

Here, 0b00 means that no action is requested to the wireless terminal apparatus 31 which receives the MOB_PAG-ADV message. Further, 0b01 means that for the Location Update, the RNG-REQ message is requested to be transmitted as it is in the idle mode to the wireless terminal apparatus 31. Further, 0b10 means that reconnection to the wireless access network 20 is requested to be performed. In addition, 0b11 means that data such as an instantaneous consumption amount acquired by the wireless terminal apparatus 31 is requested to be reported to the enterprise server 11.

In specifications of IEEE 802.16e, 0b00, 0b01, and 0b10 are defined as an Action Code capable of being included in the MOB_PAG-ADV message; however, 0b11 is undefined (in a reservation state). In the third embodiment, the undefined 0b11 is used in a report request from the enterprise server 11 to the wireless terminal apparatus 31.

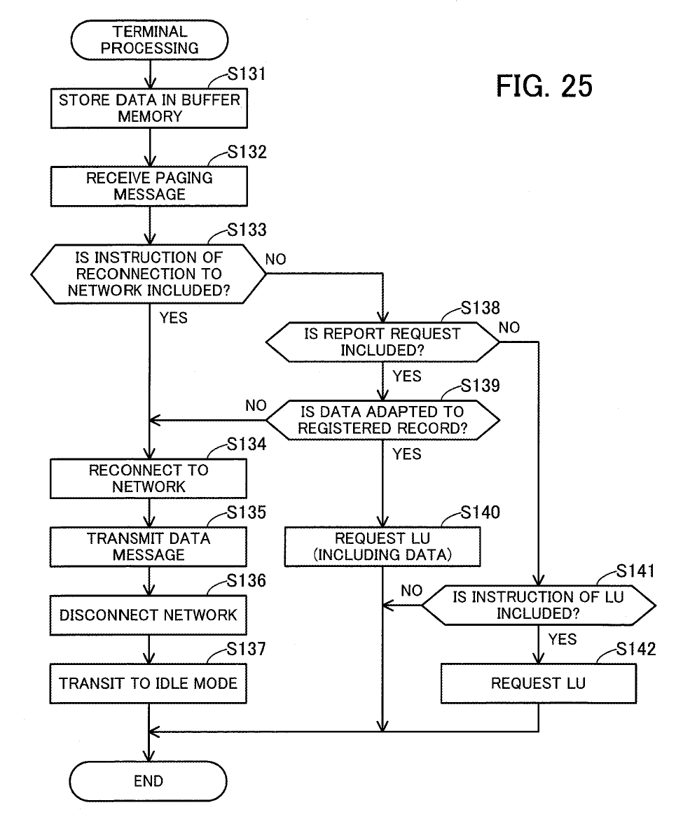

FIG. 25 is a flowchart illustrating terminal processing according to the third embodiment. The wireless terminal apparatus 31 operating in the idle mode performs a process illustrated in FIG. 25.

(Step S131) The data processing unit 313 acquires data from the measurement unit 311, and temporarily stores the acquired data in a buffer memory provided on the wireless terminal apparatus 31.

(Step S132) The communication control unit 314 receives the paging message (MOB_PAG-ADV message) broadcasted by the wireless base station 22 through the wireless communication unit 317. The communication control unit 314 receives the MOB_PAG-ADV message in the Available section.

(Step S133) The communication control unit 314 determines whether the MOB_PAG-ADV message received at step S132 includes an instruction of the reconnection to the wireless access network 20, namely, 0b10 is set as an Action Code. If so, the process advances to step S134. If not, the process proceeds to step S138.

(Step S134) The communication control unit 314 is reconnected to the wireless access network 20 through the wireless communication unit 317. Through the process, the wireless terminal apparatus 31 returns to the normal mode.

(Step S135) The data transmitting/receiving unit 316 acquires the data stored in the buffer memory, and generates a data message. The data transmitting/receiving unit 316 then transmits the data message to the wireless base station 22 through the wireless communication unit 317.

(Step S136) The communication control unit 314 performs a procedure of releasing the connection to the wireless access network 20 through the wireless communication unit 317 and transiting to the idle mode.

(Step S137) The wireless terminal apparatus 31 transits to the idle mode again. Specifically, the wireless communication unit 317 receives the MOB_PAG-ADV message at the period and timing specified at the time of the transition to the idle mode, and stops transmitting and receiving processing at the other time.

(Step S138) The communication control unit 314 determines whether the MOB_PAG-ADV message received at step S132 includes a report request, namely, 0b11 is set as an Action Code. If so, the process advances to step S139. If not, the process proceeds to step S141.

(Step S139) The data processing unit 313 determines whether the data stored in the buffer memory is adapted to any of the records (conditions and values) registered in the transfer table 312a. If so, the process advances to step S140. If not, the process returns to step S134. The data processing unit 313 is then reconnected to the wireless access network 20 and transmits the data thereto.

As described in the second embodiment, in the case where a plurality of types of data are stored in the buffer memory, only when all the data are adapted to any of the records (conditions and values) registered in the transfer table 312a, the process may proceed to step S140.

(Step S140) The communication control unit 314 generates the RNG-REQ message. Into the RNG-REQ message, the data stored in the buffer memory is inserted as a TLV. The communication control unit 314 then transmits the RNG-REQ message through the wireless communication unit 317.

(Step S141) The communication control unit 314 determines whether the MOB_PAG-ADV message received at step S132 includes an instruction of the Location Update, namely, 0b01 is set as an Action Code. If so, the process advances to step S142. If not, specifically, if 0b00 is set as an Action Code, the process ends and the idle mode is continued.

(Step S142) The communication control unit 314 generates the RNG-REQ message. The communication control unit 314 then transmits the RNG-REQ message through the wireless communication unit 317. Into the RNG-REQ message, the data stored in the buffer memory is not inserted.

As can be seen from the above sequence, when receiving an instruction of the reconnection to the wireless access network 20, the wireless terminal apparatus 31 returns to the normal mode and transmits the held data. When receiving a report request, the wireless terminal apparatus 31 includes the data in a control message and transmits the data, or transmits the data as a data message according to a type of the held data. On the other hand, when receiving the instruction of the Location Update, the wireless terminal apparatus 31 fails to transmit the held data and waits for a chance (e.g., the next timing for receiving the MOB_PAG-ADV message) of the next data transmission.

Suppose that, in the third embodiment, the wireless terminal apparatus 31 stores the data collected from the measurement unit 311 in the buffer memory. The wireless terminal apparatus 31 may further collect data from the measurement unit 311 after receiving the MOB_PAG-ADV message. In the flowchart of FIG. 25, the determination of steps S133, S138, and S141 may be performed in random order.

Incidentally, also in the wireless communication system according to the third embodiment, in the same manner as in the second embodiment, the signaling illustrated in FIG. 9 is performed and a record is registered in the transfer tables 211a and 312a each having a data configuration illustrated in FIGS. 7 and 8.

Note that, in the third embodiment, since a process of transmitting data is expressed according to the report request from the enterprise server 11, candidates for transfer conditions are expanded. Specifically, as a “Condition” of the signaling request message 41 and a “condition” of the transfer table 312a, a value of 0x05 (the Action Code is matched with the Value) may be set. At this time, in the case where the TLV type is not set at the time of the data transmission, a value of the TLV type of the transfer table 312a is preferably set to 0.

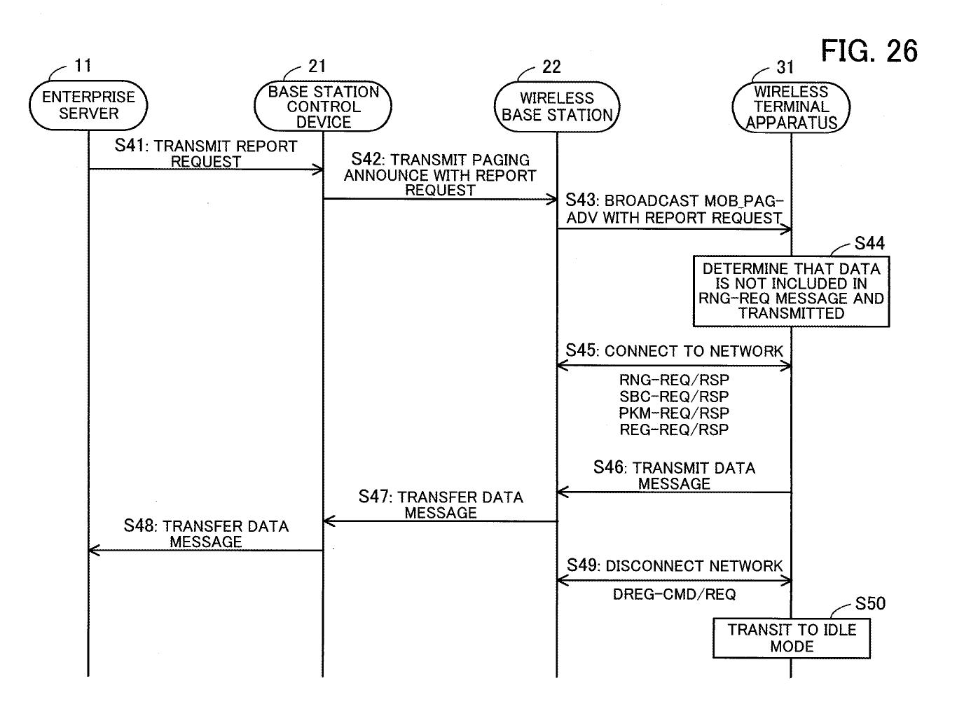

FIG. 26 is a sequence diagram illustrating a flow of a first data transfer according to the third embodiment. A sequence example of FIG. 26 illustrates a case where data is included in the data message and transmitted.

(Step S41) In the case where wishing to collect data from the wireless terminal apparatus 31, the enterprise server 11 transmits the report request message to the base station control device 21. In the report request message, a MAC address of the wireless terminal apparatus 31 is included.

(Step S42) When the report request message is received from the enterprise server 11, the base station control device 21 transmits the Paging_Announce message as a control message to the wireless base station 22 in accordance with the next timing (the next timing at which the Available section is set) at which a paging to the wireless terminal apparatus 31 is performed. In this Paging_Announce message, the Action Code (0b11) representing a report request is included.

(Step S43) When the Paging_Announce message is received from the base station control device 21, the wireless base station 22 broadcasts the MOB_PAG-ADV message. In the MOB_PAG-ADV message, an Action Code and a hash value of the MAC address of the wireless terminal apparatus 31 are included.

(Step S44) When receiving the MOB_PAG-ADV message, the wireless terminal apparatus 31 detects a paging to its own apparatus based on the hash value of the MAC address. Based on the Action Code and the transfer table 312a, the wireless terminal apparatus 31 determines that the held data is not included in the RNG-REQ message and transmitted.

(Step S45) The wireless terminal apparatus 31 performs a procedure of the reconnection to the wireless access network 20 between the wireless base station 22 and its own apparatus. Specifically, the wireless terminal apparatus 31 transmits the RNG-REQ message, the SBC-REQ message, the PKM-REQ message, and the REG-REQ message in sequence. The wireless base station 22 transmits the RNG-RSP message, the SBC-RSP message, the PKM-RSP message, and the REG-RSP message in sequence. As a result, the wireless terminal apparatus 31 operates in the normal mode.

(Step S46) The wireless terminal apparatus 31 transmits a data message to the enterprise server 11 to the wireless base station 22.

(Step S47) The wireless base station 22 transfers the data message received from the wireless terminal apparatus 31 to the base station control device 21.

(Step S48) The base station control device 21 transfers the data message received from the wireless base station 22 to the enterprise server 11 through the enterprise gateway 12.

(Step S49) The wireless terminal apparatus 31 performs a procedure of releasing the connection to the wireless access network 20 between the wireless base station 22 and its own apparatus. Specifically, the wireless terminal apparatus 31 transmits the DREG-REQ message to the wireless base station 22. The wireless base station 22 transmits the DREG-CMD message to the wireless terminal apparatus 31.

(Step S50) The wireless terminal apparatus 31 operates in the idle mode. Processes of steps S47 and S48 on the side of the wireless access network 20 and those of steps S49 and S50 on the side of the wireless terminal apparatus 31 are performed in parallel with each other.

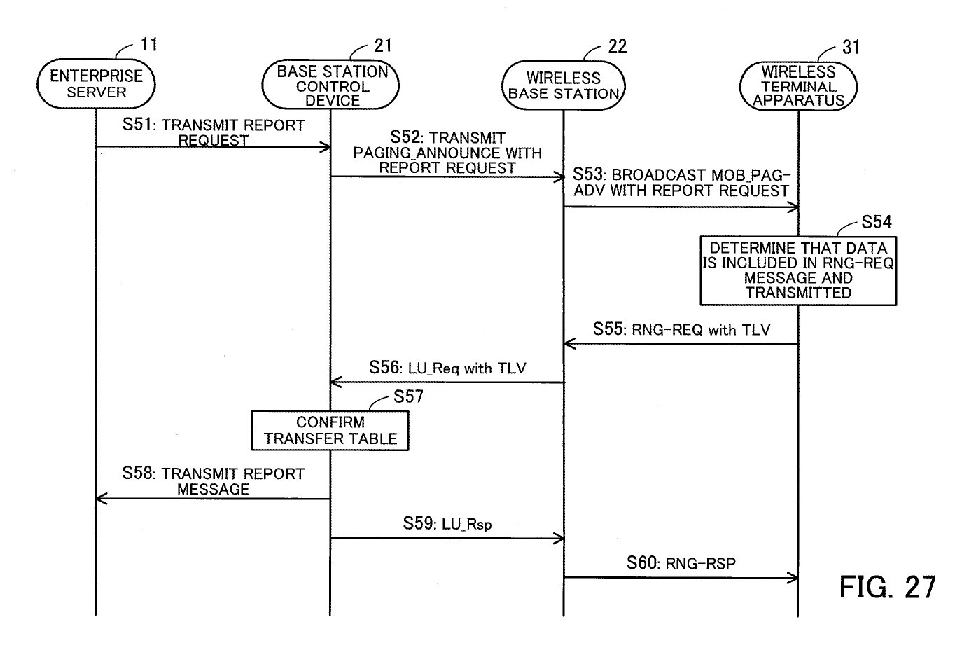

FIG. 27 is a sequence diagram illustrating a flow of a second data transfer according to the third embodiment. A sequence example of FIG. 27 illustrates a case where the data is included in the control message and transmitted.

(Step S51) In the same manner as in the step S41, the enterprise server 11 transmits the report request message to the base station control device 21.

(Step S52) In the same manner as in the step S42, the base station control device 21 transmits the Paging_Announce message to the wireless base station 22 in accordance with the next timing at which a paging to the wireless terminal apparatus 31 is performed.

(Step S53) In the same manner as in the step S43, the wireless base station 22 broadcasts the MOB_PAG-ADV message.

(Step S54) When receiving the MOB_PAG-ADV message, the wireless terminal apparatus 31 detects a paging to its own apparatus based on the hash value of the MAC address. Based on the Action Code and the transfer table 312a, the wireless terminal apparatus 31 further determines that the held data is included in the RNG-REQ message and transmitted.

(Step S55) The wireless terminal apparatus 31 includes the held data in the RNG-REQ message as a TLV and transmits the data to the wireless base station 22.

(Step S56) The wireless base station 22 includes in the LU_Req message the TLV inserted into the RNG-REQ message received from the wireless terminal apparatus 31 and transmits the TLV to the base station control device 21.

(Step S57) The base station control device 21 confirms the transfer table 211a, and extracts data to be transferred to the enterprise server 11 from the LU_Req message received from the wireless base station 22.

(Step S58) The base station control device 21 transmits a report message including the data extracted at step S57 to the enterprise server 11 through the enterprise gateway 12.

(Step S59) As a response to the LU_Req message, the base station control device 21 transmits the LU_Rsp message to the wireless base station 22.

(Step S60) As a response to the RNG-REQ message, the wireless base station 22 transmits the RNG-RSP message to the wireless terminal apparatus 31. Processes of steps S57 and S58 and those of steps S59 and S60 are performed in parallel with each other.

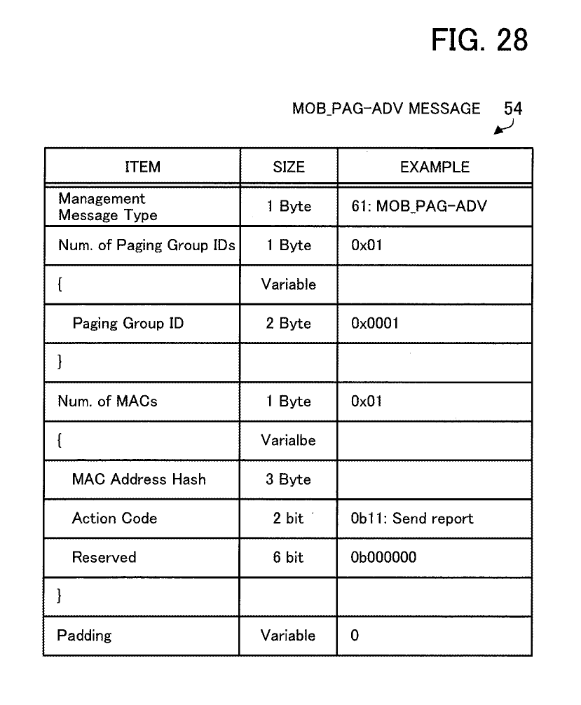

FIG. 28 illustrates an example of the MOB_PAG-ADV message. The MOB_PAG-ADV message 54 is the messages transmitted at the steps S43 and S53. The MOB_PAG-ADV message 54 includes a Management Message Type (1 byte), a Number of Paging Group IDs (1 byte), one or more Paging Group IDs (2 bytes each), a Number of MACs (1 byte), one or more MAC Address Hashes (3 bytes each), and one or more Action Codes (2 bits each).

The Management Message Type is a value indicating a type of the control message, and set to the type=61. The Number of Paging Group IDs is the number of the paging groups of paging objects. The Paging Group ID is an identifier of the paging group of the paging objects. The wireless base station 22 belongs to a plurality of paging groups. In the case where the paging of the plurality of paging groups is performed at the same timing, a plurality of Paging Group IDs are included. The Number of MACs is the number of wireless terminal apparatus of the paging objects. The MAC Address Hash is a hash value obtained from the MAC address of the wireless terminal apparatus of the paging objects. The Action Code corresponds to that illustrated in FIG. 24.

According to the third embodiment, in the same manner as in the second embodiment, the proposed wireless communication system permits the wireless terminal apparatus 31 to efficiently transmit data to the enterprise server 11. The enterprise server 11 further specifies timing of collecting data from the wireless terminal apparatus 31 and flexibly collects the data.

The method according to the second embodiment and that according to the third embodiment are combined and used. For example, some types of data may be periodically transmitted to the enterprise server 11 by the wireless terminal apparatus 31, and on the other hand, other types of data may be transmitted to the enterprise server 11 by the wireless terminal apparatus 31 after receiving a request from the enterprise server 11. In addition, in the case of collecting data on a temporary basis at timing different from the timing specified at the time of the signaling, the enterprise server 11 may use the method according to the third embodiment.

### Fourth Embodiment

Next, a fourth embodiment will be described. Since the fourth embodiment shares some elements with the foregoing second and third embodiments, the following discussion will focus on their distinctive points, omitting explanations of similar elements. In a wireless communication system according to the fourth embodiment, a wireless terminal apparatus includes data encapsulated into a packet format in a control message and transmits the data. The wireless communication system according to the fourth embodiment is implemented by using the same configuration as that of the wireless communication system according to the second embodiment illustrated in FIGS. 2 to 5. The fourth embodiment will be described below by using the same reference numerals as in FIGS. 2 to 5.

Also in the wireless communication system according to the fourth embodiment, in the same manner as in the second and third embodiments, the signaling illustrated in FIG. 9 is performed and a record is registered in the transfer tables 211a and 312a each having a data configuration illustrated in FIGS. 7 and 8. Note that, in the fourth embodiment, through the signaling, the following signaling request message 41a is transmitted from the enterprise server 11 to the base station control device 21.

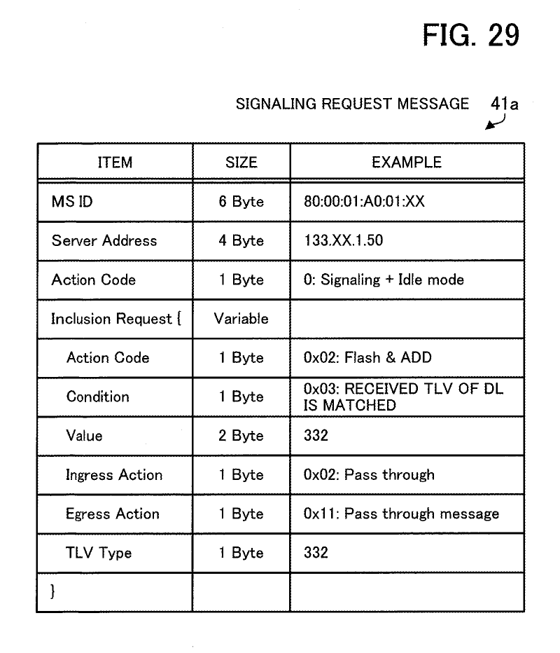

FIG. 29 illustrates another example of the signaling request message. The signaling request message 41a includes a MSID (6 bytes), a Server Address (4 bytes), an Action Code (1 byte), and one or more Inclusion Requests. The signaling request message 41a is different from the signaling request message 41 according to the second embodiment, and further includes the Action Code. The Action Code is a value indicating whether to transit to the idle mode at the time of the signaling. Here, 0 means performances of the signaling and the transition to the idle mode, and 1 means the performance of only the signaling.

Through the above-described signaling, records are registered in the transfer tables 211a and 312a. At this time, in the fourth embodiment, in the transfer tables 211a and 312a, there is registered a record corresponding to pass-through in which a message to be transferred is included in the TLV and transferred as it is.

In the transfer table 312a of the wireless terminal apparatus 31, for example, a record having a condition of 0x12, a value of 0x00, and an action of 0x11 is registered. Suppose that a communication port number of the data message produced from the data processing unit 313 is a special number of 0. In this case, this means that a format of the generated data message is not changed and the data message is piggybacked on the RNG-REQ message to transmit a data packet.

Further, in the transfer table 211a of the base station control device 21, a record having the direction of DL and the action of 0x02 or a record having the direction of UL and the action of 0x11 is registered. The former record means that as a TLV without a change in the format, the base station control device 21 transfers a message included in the IP packet received from the enterprise server 11 to the wireless base station 22 (DL pass-through). The latter record means that the base station control device 21 takes out a data message from the TLV including the data message received from the wireless base station 22 and transfers the data message to the enterprise server 11 as an IP packet (UL pass-through).

In the case where the wireless terminal apparatus 31 inserts the data message into the RNG-REQ message, a process of a communication layer such as a TCP (Transmission Control Protocol), a UDP, and an IP may be allowed to stand between the generation of the data message due to the data processing unit 313 and that of the RNG-REQ message due to the communication control unit 314. The above-described process of the communication layer is not allowed to stand therebetween and the data processing unit 313 may cooperate directly with a MAC layer.

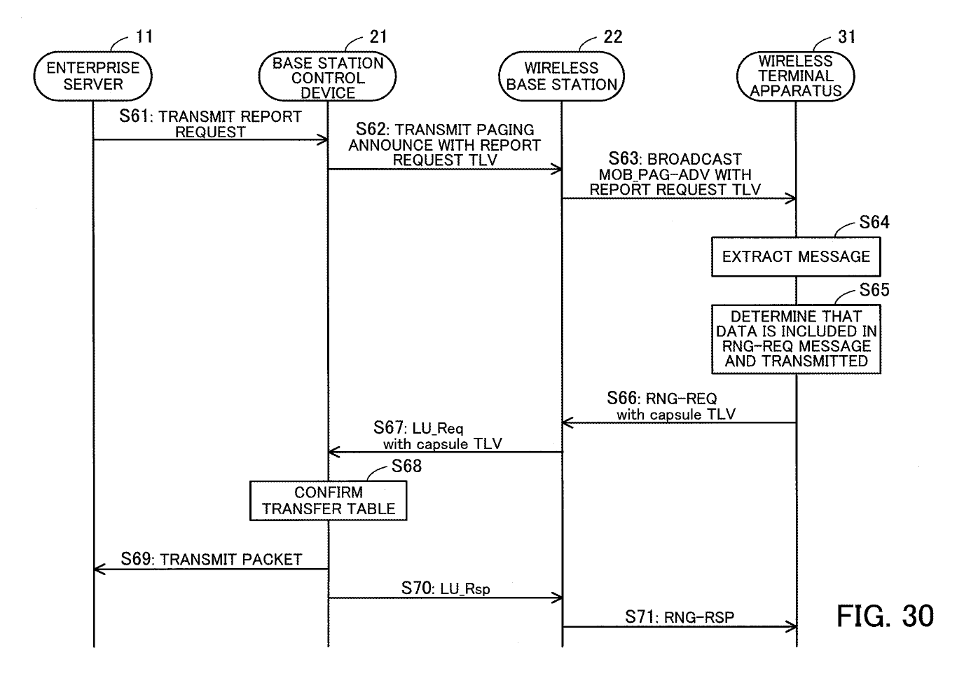

FIG. 30 is a sequence diagram illustrating a flow of the data transfer according to the fourth embodiment.

(Step S61) The enterprise server 11 transmits a report request message to the base station control device 21. This report request message is transmitted as a packet of the UDP/IP.

(Step S62) The base station control device 21 transmits the Paging_Announce message to the wireless base station 22 in accordance with the next timing at which the paging to the wireless terminal apparatus 31 is performed. Into this Paging_Announce message, the report request message included as data of the UDP/IP packet is inserted as a TLV.

(Step S63) The wireless base station 22 broadcasts the MOB_PAG-ADV message. Into this MOB_PAG-ADV message, the TLV (report request message) included in the Paging_Announce message is inserted.

(Step S64) The wireless terminal apparatus 31 extracts the encapsulated report request message from the MOB_PAG-ADV message received from the wireless base station 22.

(Step S65) The wireless terminal apparatus 31 refers to the transfer table 312a and determines that the held data is messaged, included in the RNG-REQ message, and transmitted.

(Step S66) The wireless terminal apparatus 31 generates a data message from the held data. The wireless terminal apparatus 31 then includes the generated data message in the RNG-REQ message as a TLV and transmits the data message to the wireless base station 22 (Piggyback transmission).

(Step S67) The wireless base station 22 includes the TLV (encapsulated data) inserted into the RNG-REQ message received from the wireless terminal apparatus 31 in the LU_Req message, and transmits the TLV to the base station control device 21.

(Step S68) The base station control device 21 confirms the transfer table 211a, and extracts a data message to be transferred to the enterprise server 11 from the LU_Req message received from the wireless base station 22.

(Step S69) The base station control device 21 generates a UDP/IP packet from the data message extracted at step S68. The base station control device 21 then transmits the generated packet to the enterprise server 11 through the enterprise gateway 12.

(Step S70) The base station control device 21 transmits the LU_Rsp message to the wireless base station 22 as a response to the LU_Req message.

(Step S71) The wireless base station 22 transmits the RNG-RSP message as a response to the RNG-REQ message to the wireless terminal apparatus 31. Processes of steps S68 and S69 and those of steps S70 and S71 are performed in parallel with each other.

In the above-described description, both a report request from the enterprise server 11 to the wireless terminal apparatus 31 and data from the wireless terminal apparatus 31 to the enterprise server 11 are encapsulated and transmitted, and further only any one of the report request and the data may be encapsulated and transmitted. That behavior is set through the signaling between the base station control device 21 and the wireless terminal apparatus 31.

According to the fourth embodiment, in the same manner as in the second embodiment, the proposed wireless communication system permits the wireless terminal apparatus 31 to efficiently transmit data to the enterprise server 11. In an upper layer, the wireless communication system is not conscious that data is included in a control message and transmitted or data is transmitted as a data message. Further, the wireless communication system processes a data packet and simplifies packet processing of the upper layer.

As can be seen from various embodiments discussed above, the proposed wireless terminal apparatus, communication apparatus, and wireless communication system permit data communication to be efficiently performed from a state where connection between a wireless access network and a wireless terminal apparatus is temporarily released.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention.

Although one or more embodiments of the present invention have been described in detail, it should be understood that various changes, substitutions, and alterations could be made hereto without departing from the spirit and scope of the invention.

What is claimed is:

1. A wireless terminal apparatus capable of switching between a first mode in which connection to a wireless access network is established and a second mode in which the connection to the wireless access network is temporarily released, the wireless terminal apparatus comprising:
a data processing unit configured to generate data to be transmitted to the wireless access network; and
a transmitting unit configured to include at least a part of data generated by the data processing unit during the second mode in a control message to be transmitted to the wireless access network in the second mode, and transmit the data.

2. The wireless terminal apparatus according to claim 1, wherein according to a type of data generated by the data processing unit, the transmitting unit includes the data in the control message and transmits the data, or switches from the second mode to the first mode and transmits the data.

3. The wireless terminal apparatus according to claim 2, wherein a type of data included in the control message and transmitted is set at the time of switching from the first mode to the second mode.

4. The wireless terminal apparatus according to claim 2, wherein in a case where a plurality of types of data including a type of data which is not included in the control message are collected and transmitted, the transmitting unit switches from the second mode to the first mode and transmits the plurality of types of data.

5. The wireless terminal apparatus according to claim 1, wherein:
the wireless terminal apparatus intermittently receives another control message from the wireless access network during the second mode; and
when the wireless terminal apparatus receives said another control message, the transmitting unit includes at least a part of the data generated by the data processing unit in the control message and transmits the data.

6. The wireless terminal apparatus according to claim 1, wherein:
the data processing unit converts the generated data into a packet format; and
the transmitting unit includes the data having the packet format in the control message and transmits the data.

7. The wireless terminal apparatus according to claim 1, wherein the control message is a ranging request message.

8. A communication apparatus to communicate with a wireless terminal apparatus capable of switching between a first mode in which connection to a wireless access network is established and a second mode in which the connection to the wireless access network is temporarily released and to be provided on the wireless access network, the communication apparatus comprising:
a receiving unit configured to receive a control message transmitted to the wireless access network by the wireless terminal apparatus in the second mode; and
a communication control unit configured to transfer the data to another communication apparatus in a case where a predetermined type of data is included in the control message received by the receiving unit.

9. A wireless communication system comprising:
a wireless terminal apparatus configured to be capable of switching between a first mode in which connection to a wireless access network is established and a second mode in which the connection to the wireless access network is temporarily released; and
a communication apparatus configured to be provided on the wireless access network,
wherein:
the wireless terminal apparatus includes a data processing unit which generates data to be transmitted to the wireless access network and a transmitting unit which includes at least a part of the data generated by the data processing unit during the second mode in a control message to be transmitted to the wireless access network in the second mode, and transmits the data; and
the communication apparatus includes a receiving unit which receives the control message transmitted by the wireless terminal apparatus, and a communication control unit which extracts the data included in the control message received by the receiving unit.
